(19) United States
(12) Patent Application Publication
(10) Pub. No.: US 2015/0228018 A1
(43) Pub. Date: Aug. 13, 2015

(54) SYSTEM, METHOD, AND PROGRAM PRODUCTS FOR COMPILING CREDITS ISSUED BY A TRAVEL PRODUCT PROVIDER

(71) Applicant: DATALEX (IRELAND) LIMITED, Dublin 3 (IE)

(72) Inventor: Abram RICHMAN, Petaluma, CA (US)

(21) Appl. No.: 14/618,805

(22) Filed: Feb. 10, 2015

Related U.S. Application Data
(60) Provisional application No. 61/937,989, filed on Feb. 10, 2014.

(51) Int. Cl. G06Q 40/02; G06Q 40/00; G06Q 20/40; G06Q 30/02

(52) U.S. Cl. CPC G06Q 40/025; G06Q 20/40; G06Q 30/0226; G06Q 40/12

(57) ABSTRACT

A computer-implemented system including a credit management component that consolidates all different and disparate credit forms of payment issued by airlines to their customers into a unique account (based on a common currency) owned by consumer and agency customers.

### RELATED APPLICATION

This application is a non-provisional based on U.S. Provisional Patent Application No. 61/937,989, filed Feb. 10, 2014, the contents of which are incorporated herein by reference in their entirety.

### FIELD

The present disclosure related to systems, methods, and program products for credits and charges for payment of travel expenses including, but not limited to, airline tickets.

### SUMMARY OF THE INVENTION

A computer-implemented system, method, and program product according to an exemplary embodiment of the present invention includes a credit management component that consolidates all different and disparate credit forms of payment issued by airlines to their customers into a unique account (based on a common currency) owned by consumer and agency customers. In exemplary embodiments, the credit management component links all the customer's forms of credit to a single, secured, profile that is accessible to all sales channels into a centralized account, dynamically converts balances held in different systems and currencies to the currency of the items the customer wishes to purchase at payment time, provides customers the ability to use every credit available to purchase products and services as multiple FOPs (Forms of Payment), and increases airlines ability to track, audit and report while eliminating all manual processes.

A method according to an exemplary embodiment of the present invention comprises: providing, by one or more computers, a credit bank database comprising data associated with credit accounts assigned to one or more respective customers by one or more respective travel product providers, the credit accounts associated with credit in a first currency and issued by a variety of different types of credit issuers; receiving, by the one or more computers, a request from at least one of one or more user computer systems to purchase a travel product from at least one of the one or more travel product providers using a respective credit account of at least one of the one or more customers; determining, by the one or more computers, whether to accept or deny the request based on one or more conditions; upon the condition that the request is accepted, facilitating, by the one or more computers, purchase of the travel product using the at least a portion of available credit held within the respective credit account of the at least one of the one or more customers, the step of facilitating comprising converting the at least a portion of available credit to a second currency associated with the request; upon the condition that the request is denied, refusing, by the one or more computers, purchase of the travel product using the respective credit account of the at least one of the one or more customers; and communicating, by the one or more computers, the acceptance or denial to the one or more user computer systems.

A system according to an exemplary embodiment of the present invention comprises: one or more data processing apparatus; and a non-transitory computer-readable medium coupled to the one or more data processing apparatus having instructions stored thereon which, when executed by the one or more data processing apparatus, cause the one or more data processing apparatus to perform a method comprising: providing, by one or more computers, a credit bank database comprising data associated with credit accounts assigned to one or more respective customers by one or more respective travel product providers, the credit accounts associated with credit in a first currency and issued by a variety of different types of credit issuers; receiving, by the one or more computers, a request from at least one of one or more user computer systems to purchase a travel product from at least one of the one or more travel product providers using a respective credit account of at least one of the one or more customers; determining, by the one or more computers, whether to accept or deny the request based on one or more conditions; upon the condition that the request is accepted, facilitating, by the one or more computers, purchase of the travel product using the at least a portion of available credit held within the respective credit account of the at least one of the one or more customers, the step of facilitating comprising converting the at least a portion of available credit to a second currency associated with the request; upon the condition that the request is denied, refusing, by the one or more computers, purchase of the travel product using the respective credit account of the at least one of the one or more customers; and communicating, by the one or more computers, the acceptance or denial to the one or more user computer systems.

In at least one exemplary embodiment, the variety of different types of credit issuers comprise credit issuer types selected from the group consisting of: travel banks, corporate servers, travel agency servers, electronic profile systems and loyalty award databases.

In at least one exemplary embodiment, the step of determining whether to accept or decline the request comprises: determining, by the one or more computers, whether to authorize the purchase; and determining, by the one or more computers, whether to capture the purchase.

In at least one exemplary embodiment, the step of determining whether to authorize the purchase is based on whether a first set of conditions is met, the first set of conditions comprising one or more of the following: a credit account number of the respective credit account is valid; the respective credit account is not suspended; the respective credit account is not closed; the at least one of the one or more user computer systems is associated with an authorized user of the respective credit account; a PIN matches that of an authorized user of the respective credit account; an amount authorized for the purchase is a positive amount; an available balance in the respective credit account is greater than or equal to an amount of the purchase; an available daily balance in the respective credit account is greater than or equal to the purchase amount; and the respective credit account is indicated as being available for the purchase.

In at least one exemplary embodiment, the step of determining whether to capture the purchase is based on whether a second set of conditions is met, the second set of conditions comprising one or more of the following: a credit account number of the respective credit account is valid; the respective credit account is not suspended; the respective credit account is not closed; the at least one of the one or more user computer systems is associated with an authorized user of the respective credit account; a PIN matches that of an authorized user of the respective credit account; an amount authorized for the purchase is a positive amount; an available balance in the respective credit account is greater than or equal to an amount of the purchase; an available daily balance in the respective credit account is greater than or equal to the purchase amount; the respective credit account is indicated as being available for the purchase; an expiration date of an authorization is not exceeded.

In at least one exemplary embodiment, the method further comprises the steps of: tracking, using the one or more computer systems, expiration of the credit in the one or more credit accounts; and updating, using the one or more computer systems, the one or more credit account based on the tracked expiration.

In at least one exemplary embodiment, the method further comprises the step of generating, by the one or more computers, one or more general ledger journals based on the requested purchase.

In at least one exemplary embodiment, the method further comprises the step of sending, by the one or more computers, the one or more general ledger journals to the travel product provider computer system.

In at least one exemplary embodiment, the credit comprises types of credit selected from the group consisting of: loyalty accrual/redemption, tickets purchases, flight changes/cancellations, service exception compensation, gift card purchase/redemption, promotional offers and ancillary purchases.

Other features and advantages of embodiments of the invention will become readily apparent from the following detailed description, the accompanying drawings and the appended claims.

### BRIEF DESCRIPTION OF THE DRAWINGS

The features and advantages of exemplary embodiments of the present invention will be more fully understood with reference to the following, detailed description when taken in conjunction with the accompanying figures, wherein:

FIG. 1 is a block diagram of a system for compiling credits issued by an airline to a customer according to an exemplary embodiment of the present invention.;

FIG. 2 is a block diagram showing a travel distribution and booking system according to an exemplary embodiment of the present invention

FIG. 3 shows a general application programming interface architecture of a system for compiling credits issued by an airline to a customer according to an exemplary embodiment of the present invention;

FIG. 4 shows a login process flow according to an exemplary embodiment of the present invention;

FIG. 5 shows a payment authorization process flow according to an exemplary embodiment of the present invention;

FIG. 6 shows a payment capture process flow according to an exemplary embodiment of the present invention;

FIG. 7 shows a credit sale process flow according to an exemplary embodiment of the present invention;

FIG. 8 shows a credit account inquiry screen according to an exemplary embodiment of the present invention;

FIG. 9 shows a create credit account screen according an exemplary embodiment of the present invention;

FIG. 10 shows a further aspect of a create credit account screen according to an exemplary embodiment of the present invention;

FIG. 11 shows a further aspect of a create credit account screen according to an exemplary embodiment of the present invention;

FIG. 12 shows a maintain credit account screen according to an exemplary embodiment of the present invention;

FIG. 13 shows a further aspect of a maintain credit account screen according to an exemplary embodiment of the present invention;

FIG. 14 shows a further aspect of a maintain credit account screen according to an exemplary embodiment of the present invention;

FIG. 15 shows a further aspect of a maintain credit account screen according to an exemplary embodiment of the present invention;

FIG. 16 shows a further aspect of a maintain credit account screen according to an exemplary embodiment of the present invention;

FIG. 17 shows a further aspect of a create credit account screen according to an exemplary embodiment of the present invention;

FIG. 18 shows a further aspect of a maintain credit account screen according to an exemplary embodiment of the present invention;

FIG. 19 shows a further aspect of a maintain credit account screen according to an exemplary embodiment of the present invention;

FIG. 20 shows a further aspect of a maintain credit account screen according to an exemplary embodiment of the present invention;

FIG. 21 shows a further aspect of a maintain credit account screen according to an exemplary embodiment of the present invention;

FIG. 22 shows a further aspect of a maintain credit account screen according to an exemplary embodiment of the present invention;

FIG. 23 shows a further aspect of a maintain credit account screen according to an exemplary embodiment of the present invention;

FIG. 24 shows a further aspect of a maintain credit account screen according to an exemplary embodiment of the present invention;

FIG. 25 shows a further aspect of a maintain credit account screen according to an exemplary embodiment of the present invention;

FIG. 26 shows an example of a make adjustment request according to an exemplary embodiment of the present invention;

FIG. 27 shows a statement according to an exemplary embodiment of the present invention.

FIG. 28 shows the format of an aged balances by customer account report according to an exemplary embodiment of the present invention;

FIG. 29 show child tables that may be associated with a credit account according to an exemplary embodiment of the present invention;

FIG. 30 show search keys that may be used to access a credit account according to an exemplary embodiment of the present invention;

FIG. 31 shows a child table that may be associated with an authorized user according to an exemplary embodiment of the present invention;

FIG. 32 shows a table of definitions according to an exemplary embodiment of the present invention;

FIG. 33 show child tables that may be associated with a transaction table according to an exemplary embodiment of the present invention;

FIG. 34 shows a referenced transactions table according to an exemplary embodiment of the present invention;

FIG. 35 shows a transaction type table according to an exemplary embodiment of the present invention;

FIG. 36 shows child tables that may be associated with a transaction type table according to an exemplary embodiment of the present invention;

FIG. 37 shows a transaction sub-type table according to an exemplary embodiment of the present invention;

FIG. 38 shows child tables that may be associated with a transaction sub-type table according to an exemplary embodiment of the present invention; and

FIG. 39 is a diagram showing a credit account database entity model according to an exemplary embodiment of the present invention.

### DETAILED DESCRIPTION

In the course of a customer's relationship with an airline, there are many financial interactions, including, for example, loyalty accrual/redemption, tickets purchased, flight changes/cancellations, service exception compensation, gift card purchase/redemption, promotional offers, and ancillary purchases, to name a few. Often each of these financial transaction ends in a re-usable credit issued to the customer. These credits are usually stored in disparate systems across the airline's enterprise, resulting in a number of disadvantages, such as, for example, credits being offered in different currencies or values, credits including terms and conditions for use, customers encountering difficulty in tracking credits, the application of credits to purchases being complicated by system limitations, and the complication or impossibility to use more than one credit in one purchase.

In general, there are currently severe limitations to how airlines manage customer credits and their availability to pay for services. For example, there are limitations on the capabilities for guests to view, manage and control all credits issued by an airline, there is a limited ability to trace transactions, custom (proprietary) travel banks are limited in flexibility and functionality, manual processes and workarounds are required to achieve finance and accounting functions, there is an inability to accept multiple/different forms of credit as a form of payment in the same transaction, there is limited ability for guests to use credits to pay for goods and services, and there is an inability to transfer credits to other guest accounts.

Although the present disclosure is directed to airlines, it should be appreciated that the systems and methods described herein may also be applied to other types of travel product providers, such as, for example, rental car companies, tour agencies, bus service providers, train service providers, travel agencies, and cruise ship service providers, to name a few.

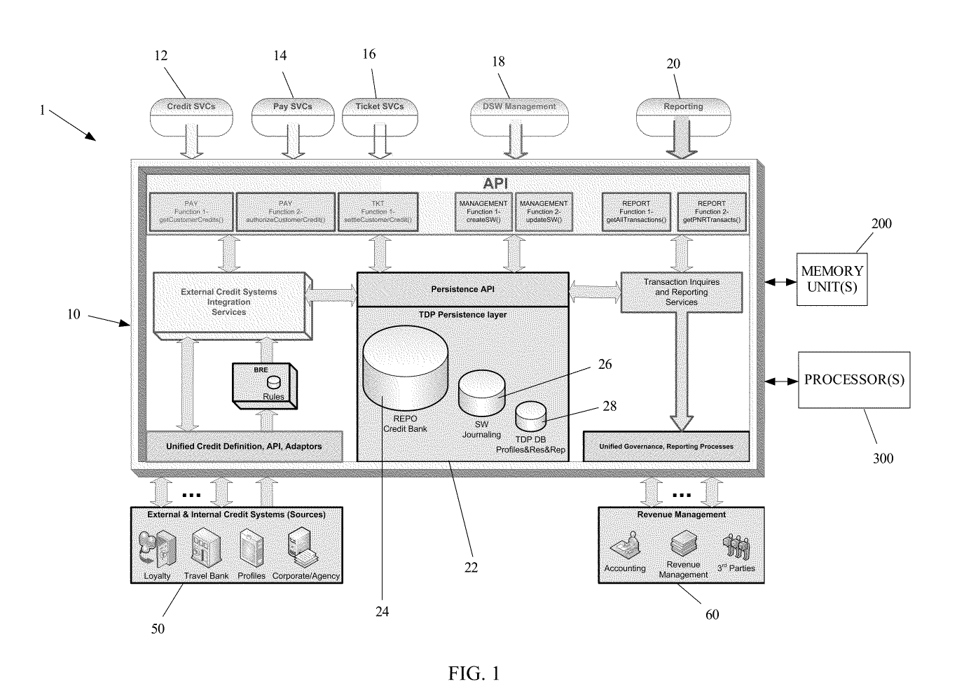

FIG. 1 is a block diagram of a system, generally designated by reference number 1, for compiling credits issued by an airline to a customer according to an exemplary embodiment of the present invention. It should be appreciated that the various components of the system 1 may be hardware components operating within one or more computers having memory and processor functionality, and in particular, the system 1 may include one or more processors that execute computing steps according to computer-readable instructions stored on non-transitory computer readable media. In this regard, the system 1 may include one or more memory units 200 and one or more processors 300 as necessary to provide a computer environment in which the various components of the system 1 may operate.

The system 1 includes a credit management component 10 that allows the consolidation of all different and disparate “credit” forms of payment issued by airlines to their customers into a unique account (based on a common currency) owned by consumer and agency customers. As explained in further detail herein, the credit management component 10 provides a comprehensive solution for customer credit management that links all the customer's forms of credit to a single, secured, profile that is accessible to all sales channels into a centralized “one account”, dynamically converts balances held in different systems and “currencies” to the currency of the items the customer wishes to purchase at payment time, provides customers the ability to use every credit available to purchase products and services as multiple FOPs (Forms of Payment), and increases airlines ability to track, audit and report while eliminating all manual processes.

In an exemplary embodiment, the credit management component 10 is provided as part of a travel distribution platform (TDP), such as the travel distribution platform described in U.S. patent application Ser. No. 13/214,813, the contents of which are incorporated herein in their entirety. However, it should be appreciated that the credit management component 10 may be provided as a stand-alone tool that allows an airline (and other types of travel service providers) to manage customer credit.

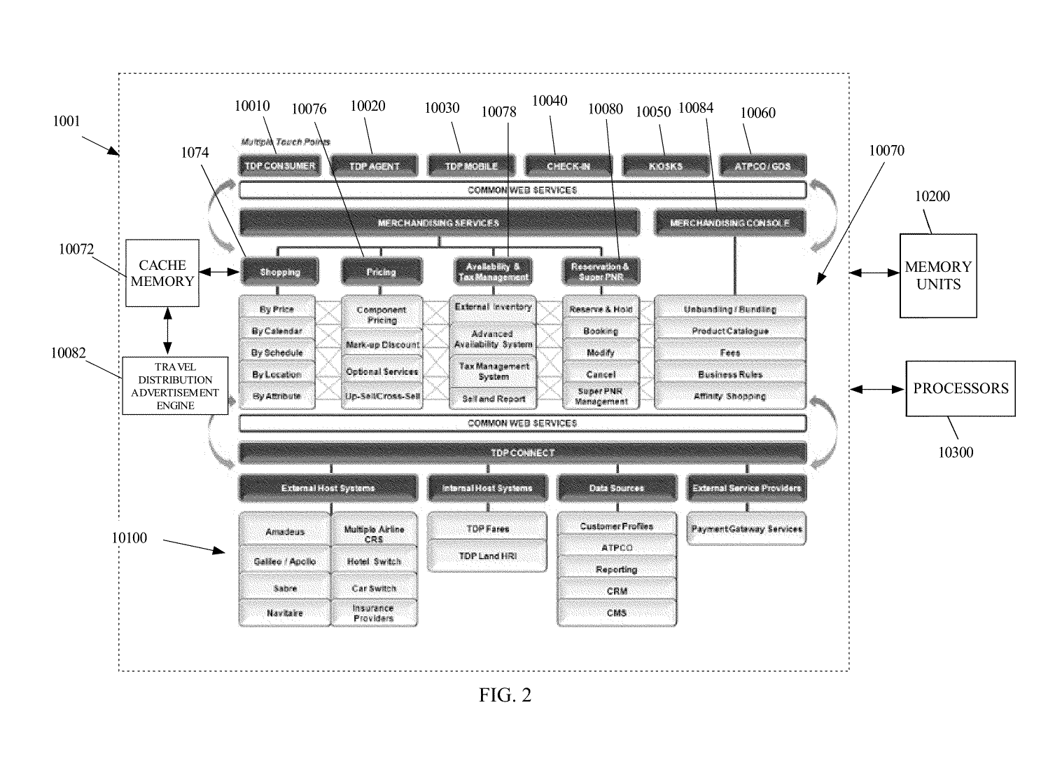

FIG. 2 is a block diagram showing a travel distribution and booking system, generally designated by reference number 1001, according to an exemplary embodiment of the present invention. The travel distribution and booking system 1001 includes point-of-sale interfaces, including, for example, a consumer interface 10010, an agent interface 10020, a mobile interface 10030, a check-in interface 10040, a kiosk interface 10050, and a GDS (Global Distribution System) interface 10060, a travel distribution platform, generally designated by reference number 10070, and a reservation system, generally designated by reference number 10100. It should be appreciated that one or more types of point-of-sale interfaces can be used with the system consistent with the present invention depending upon the design needs of the system implemented by this invention, and that each of these types of point-of-sale interfaces are not required and that this list of examples is not intended to be exhaustive. For example, other point-of-sale interfaces may be made available at call centers and affiliate distribution channels. It should also be appreciated that the various components of the travel distribution and booking system 1001 may be hardware components operating within one or more computers having memory and processor functionality, computer program product components functioning on one or more computer processors within a computer environment, or a combination of hardware and computer program product components. In this regard, the travel distribution and booking system 1001 may include one or more memory units 10200 and one or more processors 10300 as necessary to provide a computer environment in which the various components of the system may operate.

In an exemplary embodiment, the travel distribution platform 10070 is middleware disposed between one or more point-of-sale interfaces and one or more reservation systems 10100. In this regard, the travel distribution platform 10070 may be a plug-in to the reservation system 10100, or may operate independently from the reservation system 10100. In either case, as explained in further detail below, the travel distribution platform 10070 exceeds the limitations of a host layer (e.g., CRS (Central Reservation System) and GDS systems) embodied within the reservation system 10100 by receiving input from a user and querying multiple systems at the same time. Such systems to be queried include, for example, a GDS or CRS, an airline direction connection, an external or internal database of privately negotiated fares, a car or hotel switch, or any other data source identified by the customer. The limitations of the conventional host layer include, for example, inability to provide product packaging, and inability to support continuous manipulation of fares, fees, fare families and complex calendar shopping. As detailed below, the travel distribution platform 10070 is able to provide these and other features in a dynamic and relatively inexpensive manner. The travel distribution platform 10070 is able to provide features such as, for example, calendar options, fare families, e-interlining and ancillary services and fees, to name a few, and offers the flexibility and independence to shop and book for any components (air and ancillary), from any source/host, for any point of sale. In this regard, the travel distribution platform 10070 supports packaging of air, car, hotel and insurance, to name a few, both in and out of the booking path. The travel distribution platform 10070 also supports fare families (e.g., date/route/segmentation control), super PNR (Passenger Name Record), complex calendar shopping and ancillary services/fees, and also manages the reservation which may contain air and non-air components and ancillary components related to air.

As shown in FIG. 2, the travel distribution platform 10070 may include a cache memory 10072 that stores travel distribution information in the form of near real-time data related to, for example, pricing and scheduling. The travel distribution platform 10070 may intercept from shopping inquiries processed by the system results of search queries by users and store at least selected information in cache memory 10072 for later access. Data stored in cache memory 10072 may also include a date and/or time stamp data to identify the freshness of the data item. Data stored in cache memory 10072 may be monitored for freshness, and updated with separate search inquiries to better insure the timeliness and accuracy of the information. In this regard, the cache memory 10072 may be updated on a periodic basis, such as, for example, in periods of second or minutes, so as to provide near real-time data. However, it should be appreciated that in other exemplary embodiments longer or shorter update periods may be used for the cache memory 10072. Monitoring and updating of data stored in cached memory 10072 may be accomplished by a computer program product and/or computer code executing computing steps on one or more processors.

The travel distribution platform 10070 also may include merchandising service components, such as a shopping component 10074, a pricing component 10076, an availability and tax management component 10078 and a reservation and super-PNR (Passenger Name Record) component 10080. The merchandising service components may provide travel suppliers and retailers (e.g., airlines, car rental agencies, hotels, travel agents, tour operators, affiliate partners, to name a few) with a set of tools to create an innovative and independent fares pricing and management system. In general, these components allow the travel distribution platform 10070 to provide comprehensive dynamic pricing capability and diverse availability options across all itinerary types. This flexibility may support a variety of booking flows, including lowest fare, preferred flight, flexible destination search, price led search, redemption searches, branded fares and calendar shopping enabling different work flows for each distribution channel. Sophisticated faring capabilities includes ATPCO (Airline Tariff Publishing Company) fares import and pricing, GDS public/private fares pricing, one way (and combinable), multi sector and calendar pricing. Flexible destination searches may also allow customers to find the best deals to the beach or ski resort, or find destination options based on their budget.

The shopping component 10074 of the travel distribution platform 10070 may provide near real-time travel distribution information based on the data stored in the cache memory 10072. For example, the shopping component 10074 may organize the data by price, calendar, schedule, location, or by attribute, so as to allow for powerful searches using a broad spectrum of search criteria at cheaper prices compared to searches performed using conventional CRS and GDS systems. The pricing component 10076 allows for management of product pricing, such as, for example, providing for component pricing, mark-up/discount, pricing for optional services, and up-selling/cross-selling. The availability and tax management component 10078 may include an advanced availability system that allows for dynamic management of an extensive array of availability options and enables rapid and accurate responses in near real-time that significantly reduces the volume and cost of transactions required to host systems (e.g., CRS, GDS). The availability and tax management component 10078 may also include a tax management system that is linked to a tax management database containing near live tax values, which are updated on a regular basis. The tax management system reduces the number of hits to the GDS/CRS for tax information, and lowers response times for fare requests. The reservation and super PNR component 10080 may allow for reserve and hold, booking, modification and cancellation of reservations, and may also provide for customer profiling based on booking behavior. Each of the merchandising service components on the travel distribution platform 10070, such as a shopping component 10074, a pricing component 10076, an availability and tax management component 10078 and a reservation and super-PNR component 10080, may comprise computer a computer program product and/or portions of computer code executing computing steps on one or more processors.

The travel distribution platform 10070 may also include a merchandising console 10084 that provides for even more flexibility in dynamic pricing capability and availability options. For example, the merchandising console 10084 may allow for unbundling or bundling of products, the generation of a product catalogue, fees (e.g., how much to charge for a particular extra item, such as extra baggage), and affinity shopping (i.e., personalized shopping based on consumer data). The merchandising console 10084 may also include a business rules engine that gives travel suppliers and retailers control over the shopping process and manipulation of availability, fares, taxes and fees independent of the CRS/GDS. In this regard, the business rules engine may include a series of templates that allow for easy modification of information within the templates to result in implementation of a new business rule or modification of an existing business rule. The merchandising console 10084 may allow travel suppliers or retailers to configure, set-up and manage, in advance or in real-time, entire advertising campaigns, including development and input of advertisement and distribution rules, set-up and management of distribution channels, tracking use of the system and reporting. As part of the travel distribution platform 10070, the merchandising console 10084 may comprise a computer program product and/or portions of computer code configured to enable, facilitate, and/or otherwise provide the input and/or output of data, e.g., via a user. Data may be stored in or accessed from non-transitory computer readable memory and/or in one or more databases.

The point of sale interfaces, including the consumer interface 10010, agent interface 10020, mobile interface 10030, check-in interface 10040, kiosk interface 10050, and GDS interface 10060 may be generated by the travel distribution platform 10070. These point of sale interfaces may comprise a computer program product and/or portions of computer code configured to enable, facilitate, and/or otherwise provide the input and/or output of data, e.g., via a user. Data may be stored in or accessed from non-transitory computer readable memory and/or in one or more databases. In this regard, the point of sale interfaces may display the near real-time data intercepted and organized by the travel distribution platform 10070 so as to provide the user with search results and booking information in a rapid and flexible manner. For example, the consumer interface 10010 provides an online booking platform that lets a travel supplier or retailer to drive its direct online channel and profitability by offering merchandised fares and ancillary content via a one-stop shopping solution as part of a multi-channel strategy. The consumer interface 10010 reduces distribution costs by moving customers away from call centers, reducing call volume and providing a self-service tool that allows customers to take control of their reservations. The consumer interface 10010 may also provide a multi-lingual and multi-currency point of sale so as to reach customers in all global markets and tailor their online experience.

As shown in FIG. 1, the system 1 may include data input/output interfaces including, for example, a credit interface 12, a payment interface 14, a ticketing interface 16, a credit management interface 18 and a reporting interface 20. The input/output interfaces may comprise a computer program product and/or portions of computer code configured to enable, facilitate, and/or otherwise provide the input and/or output of data, e.g., via a user. Data may be stored in non-transitory computer readable memory and/or in one or more databases. The credit interface 12 may allow for input/output of credit information data, such as, for example, credit obtained by a customer and credit being offered to a customer. The payment and ticket interfaces 14, 16 may allow for input/output of payment and ticket information data, such as, for example, whether all or partial payment for a ticket has been received, the payment amount, payment balance due for a ticket, whether customer credit can be applied to a ticket and application of customer credit to a ticket. The management interface 18 may allow for input/output of management data used to manage the credit management component 10, such as, for example, generation of a customer profile (e.g., the profile of an airline that intends to use the credit management component 10 or the profile of a customer of the airline) and updating of the customer profile and related information. The reporting interface 20 may allow for input/output of reporting information, such as, for example, reports regarding transactions, balances, credits, etc.

The credit management component 10 may also include a persistence component 22 that includes various databases and repositories that store data such as, for example, data related to user credits, profiles and reservations. In this regard, the persistence component 22 may include a credit bank 24, a journaling database 26 and, in exemplary embodiments in which the system 1 is linked with or otherwise in electronic communication with a travel distribution platform, a TDP database 28.

The credit bank 24 may act as a general purpose credit account for customers, enabling a balance of credits to be maintained for each customer as a generic fulfillment mechanism for other forms of payment. For example, the credit bank 24 may provide airline customers the ability to grant and maintain commercial credit accounts to enrolled travel agencies and corporate customers. Additionally, the credit bank 24 may provide consumer customers the ability to store and use credits earned for things such as non-refundable ticket residual amounts, service compensation credits, and other redeemed value documents.

Credit account details and transactions may be stored in a secure, highly available database. A scalable web service interface may be provided to support all account maintenance and credit transactions. The web interface may comprise a computer program product and/or computer code running on one or more processors, such computer program product and/or computer code configured to enable, facilitate, and/or otherwise provide the input and/or output of data in one or more databases, e.g., via a user.

External and internal credit systems 50 may function in cooperation with the credit management component 10, as necessary. Such systems may include, for example, travel banks, corporate servers, travel agency servers, electronic profile systems, and loyalty award databases, to name a few. This cooperation may occur through one or more communications portals and/or be performed by one or more computer program modules.

Revenue management 60 may function in cooperation with the credit management component 10, as necessary. This cooperation may occur through one or more communications portals and/or be performed by one or more computer program modules. In this regard, accounting, revenue management and third party services may be provided. Such services may be provided by one or more input/output interfaces and/or by a computer program product and/or portions of computer code operating on one or more processors and accessing non-transitory computer readable media.

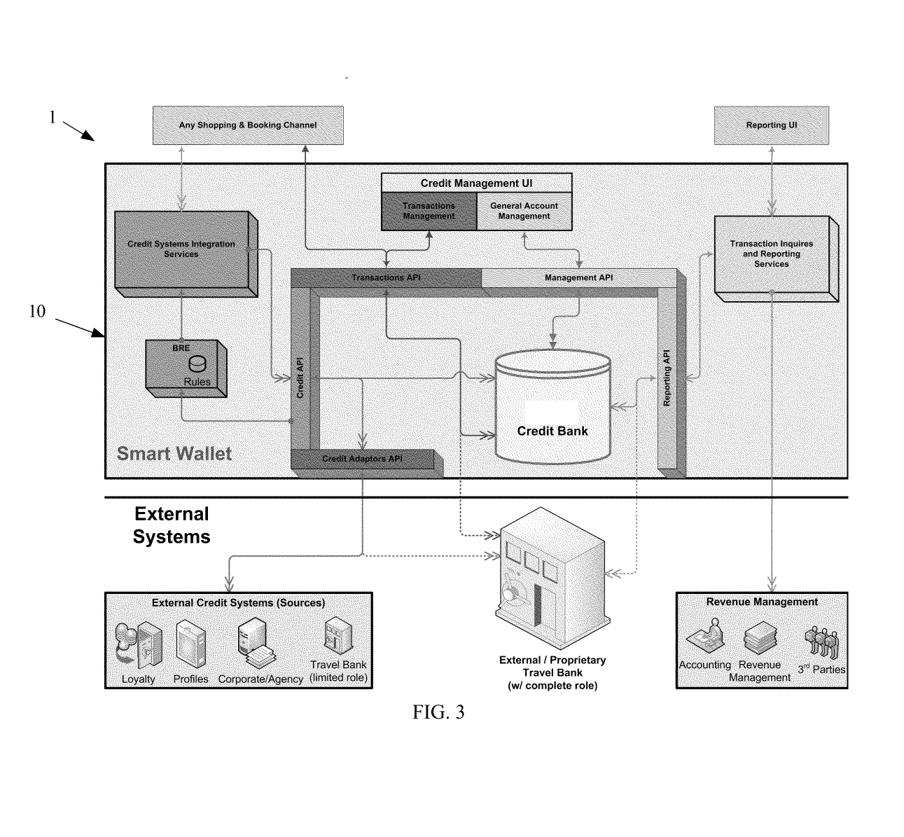

FIG. 3 shows a general application programming interface (API) architecture of the system 1 according to an exemplary embodiment of the present invention. The functions of the API may be achieved by use of, but is not limited to, one or more computers or computer systems having at least one or more processors, computer-readable memory comprising one or more databases, one or more communications portals for communicating with one or more other computers or computer systems, one or more input devices, and/or a computer program product configured to enable, facilitate, and/or otherwise provide the input and/or output of data in one or more databases, e.g., via a user. The Credit API 70 may be a computer program product and/or hardware configured to achieve the following functions: getCustomerCredits( ): retrieve all credits, it may allow access to the external sources (via an internal API defined for different adaptors), if a Travel Bank exists, it may process credits from there (retrieve, authorize/settle), and if a Travel Bank does not exist, it may allow the use of the credit bank 24, to name a few.

The Transactions API 72 may be a computer program product and/or hardware configured to achieve the following functions: authorizeCustomerCredits( ): pay with some of credits retrieved, settleCustomerCredits( ): during ticketing phase (potentially) settle the payment made on customer, it may either direct the transactions to Travel Bank or credit bank 24, and it may have functions for credit bank 24 to manually manage transactions into a user credit account, to name a few.

The Management API 74 may be a computer program product and/or hardware configured to achieve the set of functions associated with management of credit bank 24 and it may expose functions to create accounts, manage accounts, and associate accounts with users from profile data base.

The Reporting API 76 may be a computer program product and/or hardware configured to achieve reporting functions to UI/external services and allow data to be pulled either from a Travel Bank or credit bank 24.

The Credit Adaptors API 78 may comprise a computer program product and/or hardware configured to be an internal API defined for adaptors that will connect to external credit sources compiled on one or more databases and aggregate data into a unified credit element.

A comprehensive set of management screens and reports may be provided through the operation of, e.g., the hardware, computer program products, and/or databases of system 1 to achieve functions such as, for example, Create, Activate, and Deactivate Credit Accounts, Set and Maintain Overall and Daily Credit Limits, Maintain Authorized Users and Reset PIN Numbers, Inquire On Credit Transaction Details, Adjust Credit Balances, Post and Apply Payments, Write Notes for an Account, Inquire on Access History for an Account, and Initiate Reports, to name a few.

Once established and linked to a valid system login profile stored on one or more databases, a credit bank number can be used as a form of payment for ticketing and other payment transactions. A TDP may provide an authorization and capture web service interface comprising a computer program product configured to communicate with one or more databases to validate and record the sales and credits for a credit account.

Transaction Flows

The following flows may be supported from various interfaces, such as, for example, the TDP consumer UI, Travel Agency Portal, Corporate Portal, and Mobile Application, to name a few. These interfaces may comprise a computer program product and/or portions of computer code configured to run on one or more processors and enable, facilitate, and/or otherwise provide the input and/or output of data to and/or from one or more databases, e.g., via a user.

Login

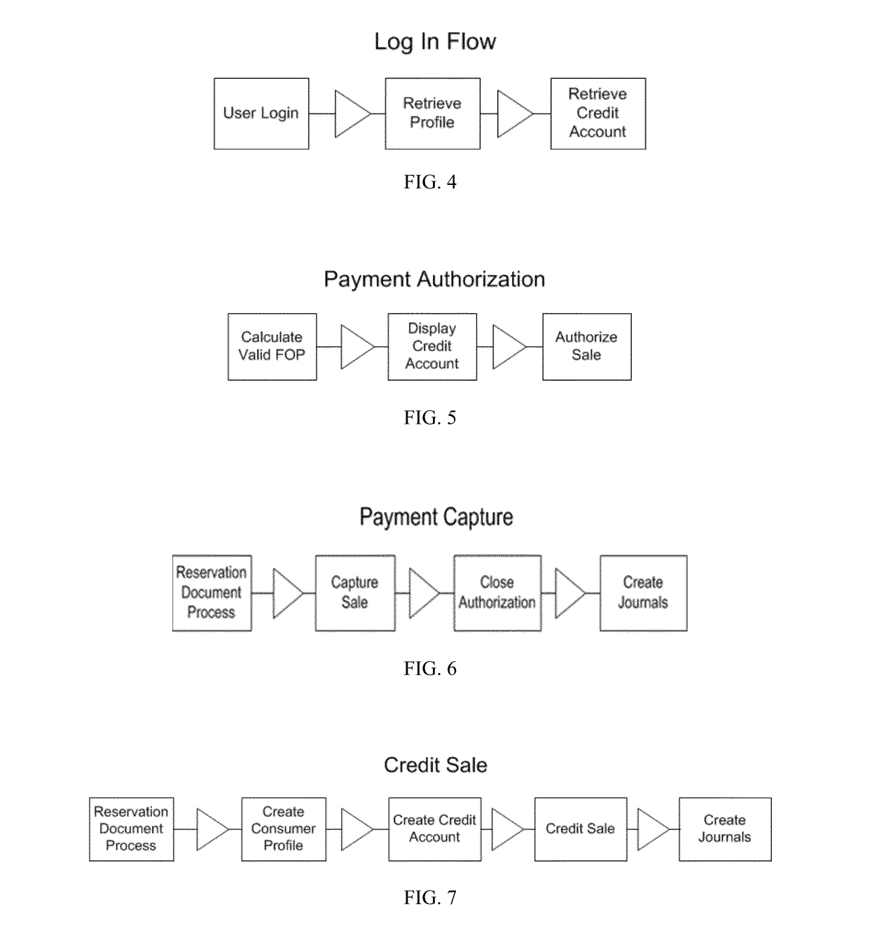

As shown in FIG. 4, in an embodiment, the system comprises a computer program module and/or portions of computer code configured to retrieve a credit account linked to a user profile from one or more databases when a consumer, agency agent, or corporate user logins into TDP. This action may return the credit account details, overall credit limit, daily transaction limit, available balance and available daily balance information.

Payment Authorization

As shown in FIG. 5, the TDP process that calculates valid forms of payment for a shopping cart may return the credit account as a form of payment if it is valid for the transaction and there is an available balance as recorded in an accessed database. When the sale is submitted via the TDP, the authorization process may be called to re-check available balances, reserve the amount of the sale, and return an authorization number and date. In an exemplary embodiment, if the account is PIN protected, the user's PIN must match the PIN sent in the authorization request.

Payment Capture

As shown in FIG. 6, in an embodiment the system comprises a computer program module and/or portions of computer code configured to enable, facilitate, or otherwise provide for the TDP reservation document service to use the credit account retrieved from a database as the form of payment for tickets and other charges by passing the account, authorization number, and date to the capture sale process. Credit account numbers may conform to the same format as commercial credit cards. This format may be acceptable by reservation host systems in ticketing transactions. The credit account may become one of the ticket forms of payment processed by the system 1.

When ticketing is successfully completed by the TDP, the authorized transaction may be updated to close the authorization and set the disposition of the transaction to “captured”. Detail balanced G/L (General Ledger) journal entries may be produced for the transaction and submitted to the airline's financial system database or databases at day end, or on another periodic basis.

Credit Sale

When consumers change or cancel their reservations and have a residual refund amount after paying penalties that is not refundable, but can be used for future purchases, the credit bank 24 can store this credit in a database or databases for later use.

If the consumer user is logged in and has a profile and a credit bank account, the refund may be credited to that account in the relevant database or databases. If the consumer user is logged in, but does not have a credit bank account, an account may be created and stored in one or more databases and linked to the profile automatically.

If the user in not logged in, but he enters an email and/or telephone number which matches a valid profile in one or more databases, he may be prompted to login.

If the user is not logged in and does not have a matching profile, he may be prompted to verify the information (from the original sale) for auto-creation of a profile and credit account.

As shown in FIG. 7, the reservation document process may credit the refund balance to the account recording the redeemed document number(s). Transactions and G/L journals may be produced and stored in one or more databases.

Adjustments and Payments

To make adjustments and post and apply payments to the account, the airline credit administrator may use a credit account management user interface tool. The management user interface may comprise a computer program product and/or portions of computer code configured to enable authorized credit administrators to access credit accounts and maintain account information stored in a database as well as make adjustments and payment transactions.

All transactions made by credit administrators may be logged in an access table in one or more databases. Additionally, account functions may be individually controlled by security roles connected to the administrator's user account as stored on one or more databases and recognized by the interface computer program product processes.

Reconciliation

A periodic process may be provided by a computer program module that processes a standard Agency Sale Report file (ASR) that contains transactions that use the credit account form of payment and reconciles charges and credits from the report with the credit bank transaction database.

Credits completed outside of TDP such as refunds from non-TDP sources may be captured and added to the credit bank transaction database. Sales made outside of TDP using credit accounts may be flagged for research and can be made as a manual adjustment.

Actors

Credit Administrator

The Credit Administrator may be an employee of the airline who manages direct credit accounts granted to customers of the airline. The Credit Administrator may be responsible for granting and monitoring the use of credit granted the customer by the airline.

The Credit Administrator may create and activate credit accounts, set and maintain credit limits, add and remove authorized users from the credit account, apply payments and adjust credit balances.

Account Holder

The Account Holder may be a consumer customer, a travel agency customer, corporate customer or the airline that has been granted a credit account with the airline. The Account Holder may be represented by a customer contact.

A credit account may be opened for any of the customer types listed above. In an exemplary embodiment, credit terms and a credit line are not granted to a consumer customer. The consumer customer may use the credit account as a means to store and use airline issued credits for such things as the residual of refunded or exchanged tickets, and other items such as service compensation, or promotional awards.

Customer Contact

A Customer Contact is the primary representative of the Account Holder who can be contacted by the Credit Administrator to discuss details of a credit account. In the case of a consumer customer, this is the customer himself. For a travel agency customer, this is usually the primary agency administrator. For a Corporate Customer, this is usually the primary corporate administrator.

The Credit Administrator may link any Authorized User of the account to be the Customer Contact.

Authorized User

An Authorized User is any employee or representative of the customer that is authorized to use the credit account for payment transactions through TDP. For example, an Authorized User must have an active profile of one of the following types: Traveler Profile, Agency/Agent or Administrator, Corporate Account/Travel Arranger or Administrator. It may also be a requirement that an Authorized User have a valid user account in the system.

Credit Account Management UI Flow

According to an exemplary embodiment, a credit account management user interface (MUI) flow may be as follows: the Credit Administrator logs into the MUI and accesses the credit account management facility through a new menu option on the MUI. In an exemplary embodiment, the Credit Administrator must have certain role codes connected to his login to access the credit account facility. In an embodiment, the MUI comprises computer a computer program product and/or portions of computer code configured to run on one or more processors and enable, facilitate, and/or otherwise provide the input and/or output of data to and/or from one or more databases, e.g., via a user.

Credit Account Inquiry

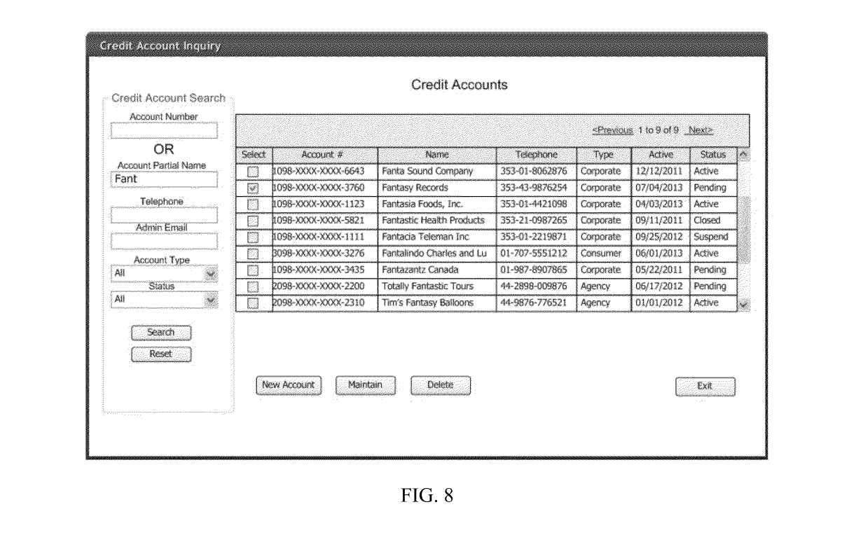

As shown in FIG. 8, in an embodiment, a MUI may comprise a computer program module and/or portions of computer code which enables, facilitates, or otherwise provides for a Credit Administrator to begin all management tasks with a Credit Account Inquiry screen on a MUI. The Credit Administrator may lookup credit accounts on a MUI by account number or may enter a search criteria including Account Partial Name, Contact Email, Contact Phone.

The Credit Administrator may also use a MUI to filter the list by account type and/or account status.

A list of credit accounts matching the criteria may be presented by a MUI. The Credit Administrator may select an account presented by a MUI to maintain or delete. In an exemplary embodiment, deletion can only occur if the account is closed and has no transactions.

The Credit Administrator may create and store a new credit account on one or more databases by selecting “New Account” through a MUI. The “New Account” function on a MUI may be controlled by a special security role that allows for credit account creation. If the Credit Administrator does not have this role connected to his user account on a MUI, the button may not be shown on the interface.

Create Credit Account

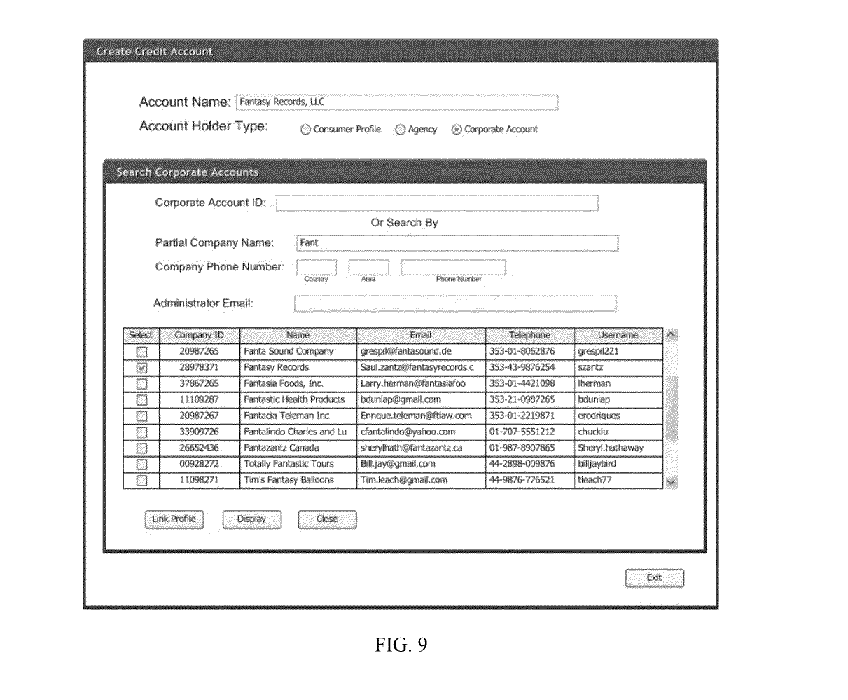

As shown in FIG. 9, in an embodiment, a MUI may comprise a computer program module and/or portions of computer code which enables, facilitates, or otherwise provides for a Credit Administrator to be presented with a Create Credit Account screen on a MUI that prompts him to enter the name of the credit account and to select the type of profile the account will be linked to on one or more databases. In an exemplary embodiment, every credit account must be linked to a valid profile accessible in TDP. This profile may be one of: Traveler Profile, Agency/Agent Administrator Profile, and/or Corporate Account/Corporate Administrator Profile.

When the Credit Administrator clicks one of the radio buttons on a MUI indicating the Account Holder type, he may be prompted with a search screen to search for the existing profile of the Account Holder type selected. He may search by profile ID or by: Partial Name, Phone, Email, for example.

In an embodiment, a MUI may comprise a computer program module and/or portions of computer code which enables, facilitates, or otherwise provides for a list of possible profile matches to be retrieved from one or more databases. The Credit Administrator may select the account to “link” to the new credit account on one or more databases or may display the profile via the MUI for further identification.

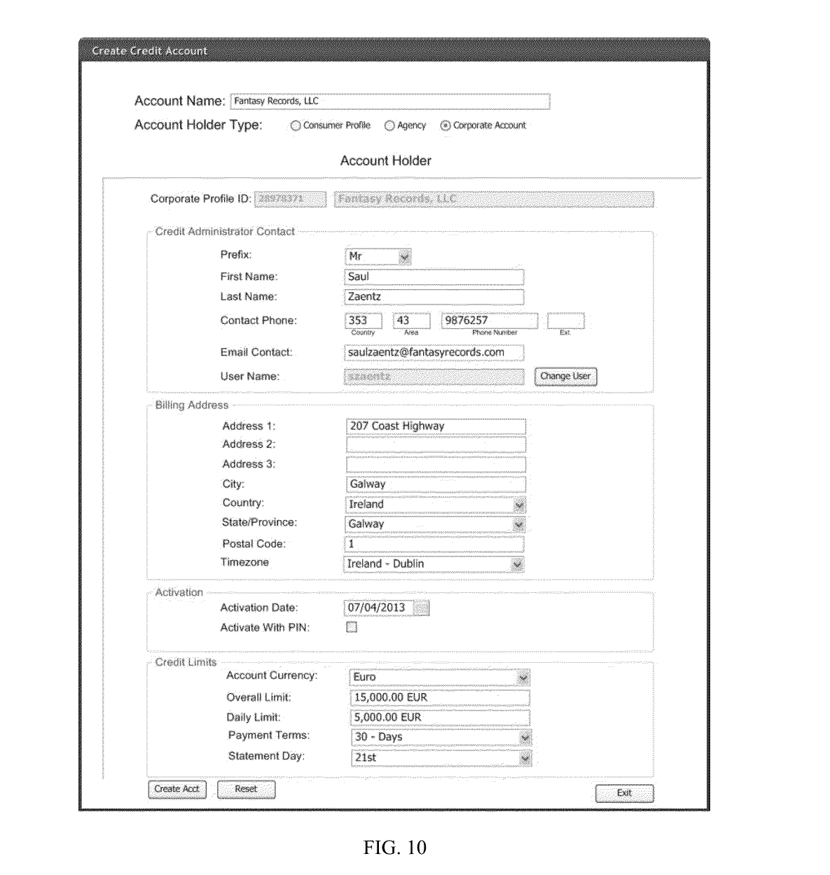

As shown in FIG. 10, in an embodiment, a MUI may comprise a computer program module and/or portions of computer code which enables, facilitates, or otherwise provides for the remainder of the account creation screen may be shown when the desired profile is selected and the “Link” button is clicked.

Account Contact Information and Account Holder

In an embodiment, a MUI may comprise a computer program module and/or portions of computer code which enables, facilitates, or otherwise provides for the linked profile and user to become the Account Holder and Customer Contact, respectively. By definition, the Customer Contact may also become an Authorized User of the account, and designated as such on one or more databases. The Account Holder and Customer Contact information may be copied from the linked profile and user information stored on one or more databases. This information may be subsequently changed via the MUI by the Credit Administrator.

If the Credit Administrator realizes that the linked account is incorrect, he may select a “Change User” function via the MUI to reset the linked account stored on one or more databases. On clicking the “Change User” button, he is shown the same profile search prompt from the initial step.

Activation

In an embodiment, a MUI may comprise a computer program module and/or portions of computer code which enables, facilitates, or otherwise provides for a Credit Administrator to set the date for activation of the credit account via the MUI. In an embodiment, the activation date linked with the credit account on one or more databases may be “today” or any future date. In an embodiment, the activation time associated with the account may be midnight, based on the time settings of the TDP server.

In an embodiment, a MUI may comprise a computer program module and/or portions of computer code which enables, facilitates, or otherwise provides for a Credit Administrator to use a MUI to set the account to be protected by a PIN code. This means that all Authorized Users may be assigned an individual PIN code associated with their respective accounts stored on one or more databases when they become an Authorized User. In an exemplary embodiment, if this setting is selected for the account stored on one or more databases, a PIN code must be used by the Authorized User when paying with a credit account on the system. The PIN code may be emailed by, e.g., the MUI to the Authorized User as part of the step of assigning the user to the account. In an exemplary embodiment, the Account Holder is always the first Authorized User, and will receive a PIN code on creation of the credit account.

Initial Credit Limits

In an embodiment, a MUI may comprise a computer program module and/or portions of computer code which enables, facilitates, or otherwise provides for a Credit Administrator, if he has the proper security role enabled on his account as stored on one or more databases, to use a MUI to set an initial credit limit, credit account currency, payment terms, and statement ending day of month for the account. In an embodiment, the Credit Administrator may use a MUI set an overall credit limit, a daily credit limit, credit terms, and a statement ending day of month.

Creation

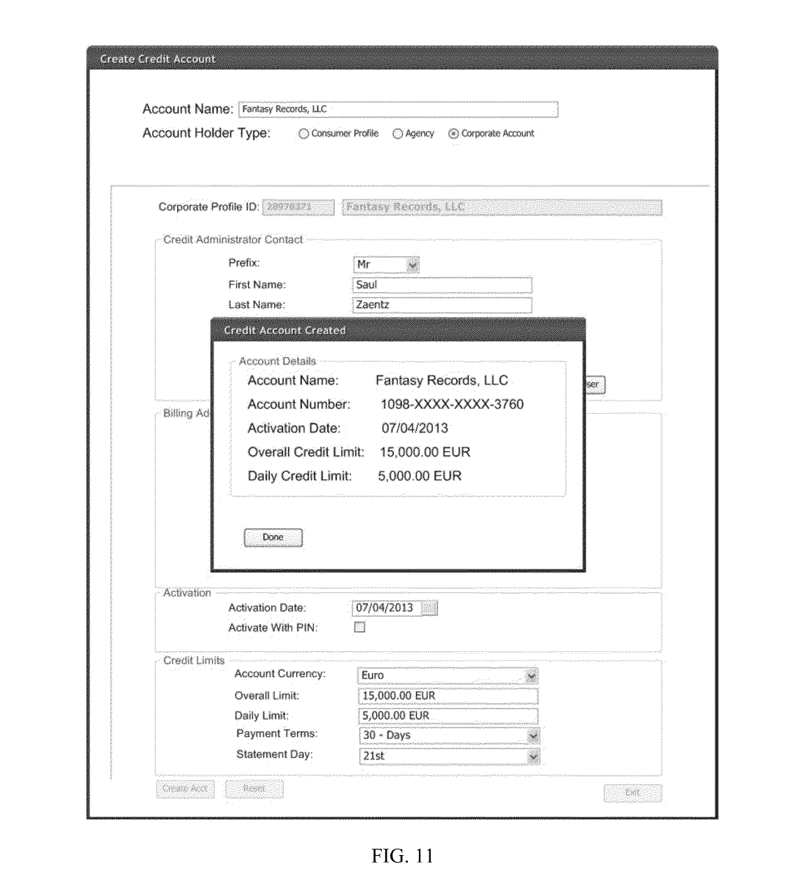

As shown in FIG. 11, in an embodiment, a MUI may comprise a computer program module and/or portions of computer code which enables, facilitates, or otherwise provides for data to be validated when a Credit Administrator clicks the “Create Account” button on a MUI, and the credit account is created and stored on one or more databases. In an embodiment, the MUI may sent the Account Holder/Customer Contact an email indicating that the account has been created and gives the individual PIN if the account is PIN protected. In an embodiment, a response popup may be shown on a MUI on successful creation of an account.

Maintain Credit Account

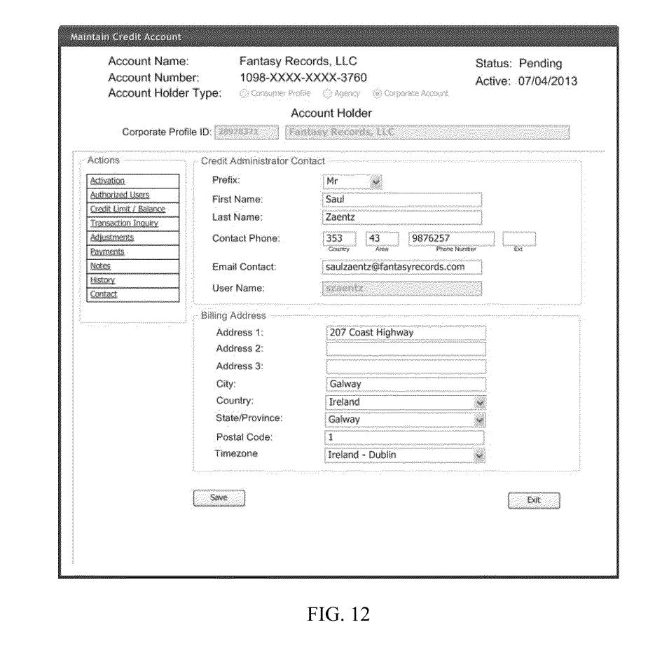

As shown in FIG. 12, in an embodiment, a MUI may comprise a computer program module and/or portions of computer code which enables, facilitates, or otherwise provides for a credit account manager to select an account returned by the inquiry for maintenance on a MUI. Based on the Credit Administrator's roles codes as associated with his account stored on one or more databases, the MUI may permit him to use the MUI to perform the following functions for an account: Maintain Contact Information, Activate an Account, View Balances and Set Credit Limits, Inquire on Transactions and View Transaction Details, Make Credit Adjustments, Apply Payments, Maintain and Read Account Notes, View Access History, Maintain Contact Information

The Main Contact Information link on a MUI may allow the account manager to display and maintain credit account contact information.

Activate an Account

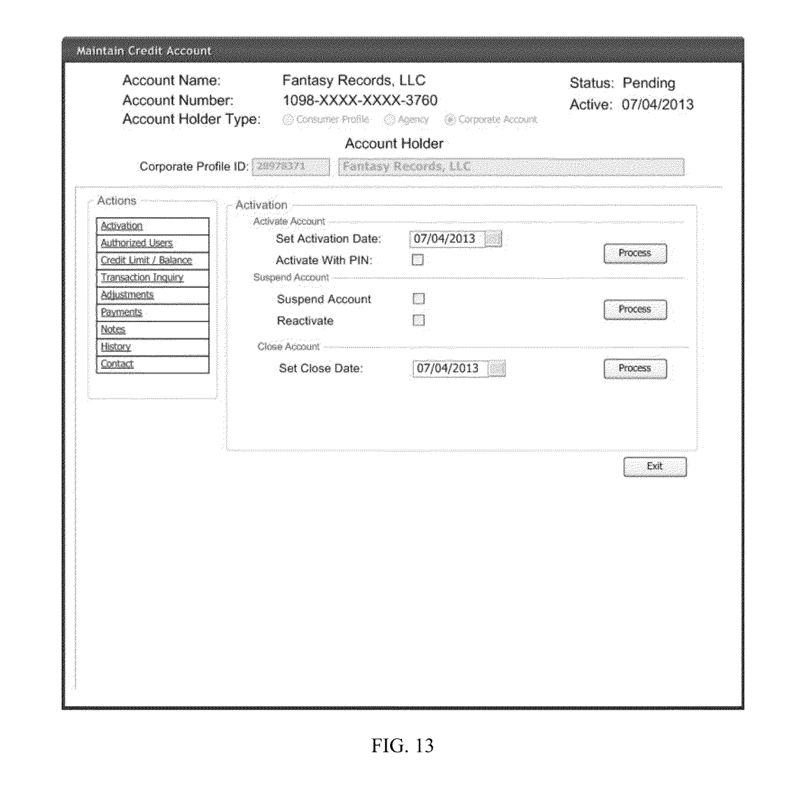

As shown in FIG. 13, in an embodiment, a MUI may comprise a computer program module and/or portions of computer code which enables, facilitates, or otherwise provides for an Activate Account Section to allow the account manager to set the active date for a new account, to suspend, and close the account and store this associated account data on one or more databases. In an embodiment, when activating the account, the administrator may use the MUI to signify whether the account is PIN protected or not and link that associated data with the account on one or more databases.

The ability to activate, suspend, or close an account may be secured by role code of the MUI user as linked to the user account on one or more databases.

Authorized Users

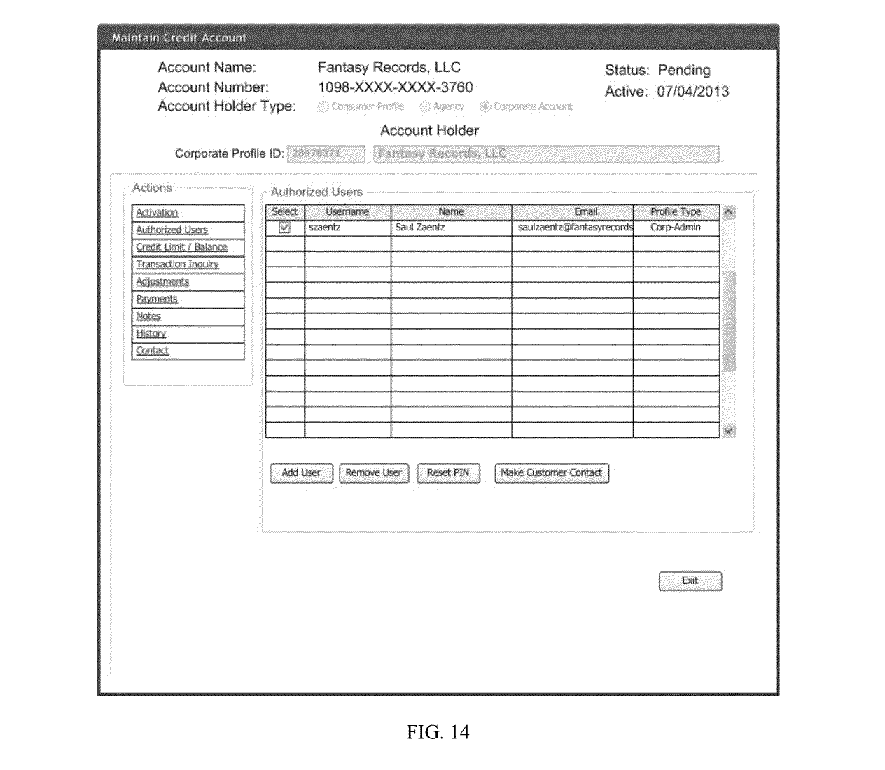

As shown in FIG. 14, in an embodiment, a MUI may comprise a computer program module and/or portions of computer code which enables, facilitates, or otherwise provides for an Authorized Users section to display all of the active users of a credit account and allow the Credit Administrator to add new Authorized Users, remove Authorized Users, generate a new PIN code and email it to an Authorized User, and to change the Authorized User who will be the Customer Contact for the credit account.

View Balances and Set Credit Limits

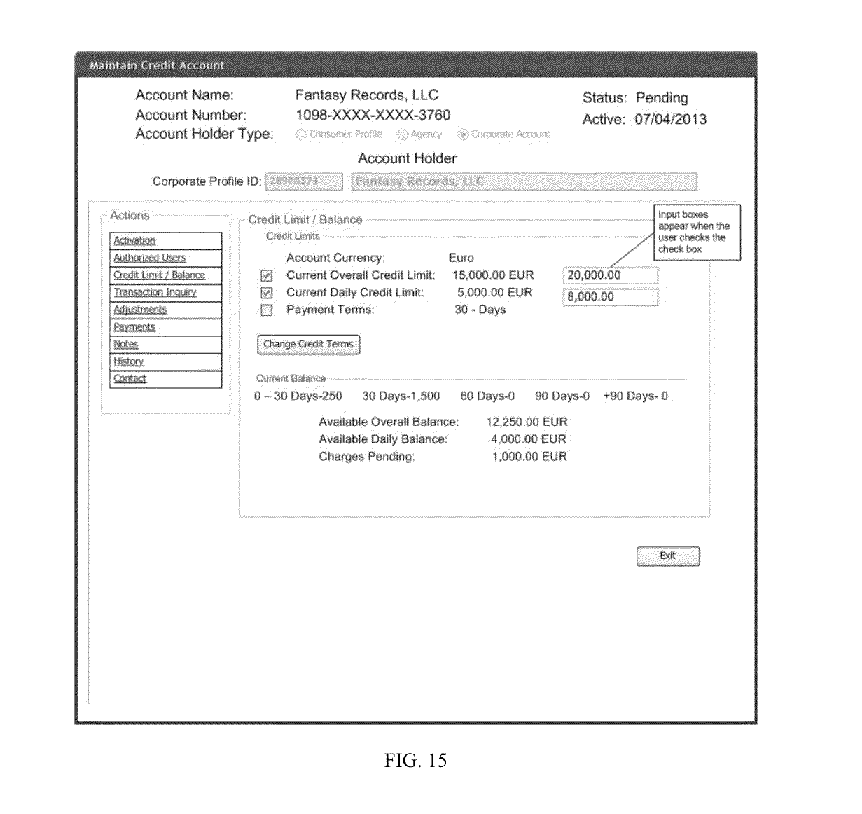

As shown in FIG. 15, in an embodiment, a MUI may comprise a computer program module and/or portions of computer code which enables, facilitates, or otherwise provides for a Credit Limit/Balances linkto show the account overall credit limit, the daily credit limit, and the account's credit terms. In an embodiment, the section may show the available overall balance, the daily available balance, the pending (authorized but not captured) charges, and a quick ageing analysis of invoices due.

In an embodiment, a MUI may comprise a computer program module and/or portions of computer code which enables, facilitates, or otherwise provides for a Credit Administrator, if he has the proper security roles maintained for his user account as recorded on one or more databases, to modify any of the credit limits for an account stored on one or more databases.

Inquire on Transactions and View Transaction Details

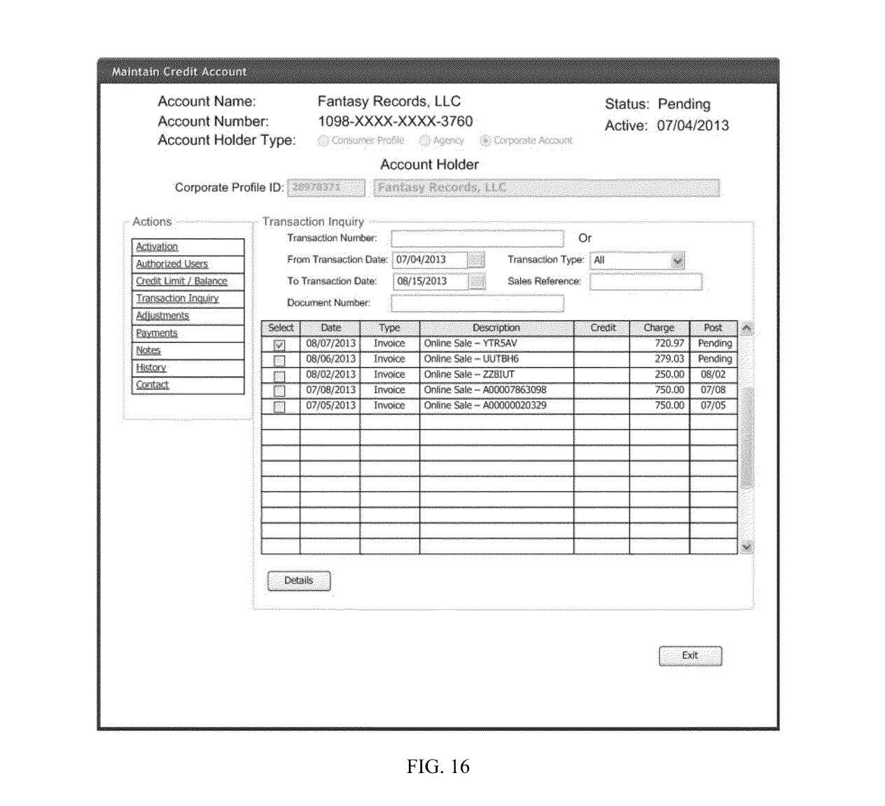

As shown in FIG. 16, in an embodiment, a MUI may comprise a computer program module and/or portions of computer code which enables, facilitates, or otherwise provides for a Credit Administrator to search for and display the transactions for a selected credit account stored on one or more databases. The user may use the MUI to search by specific transaction ID or he may search by any of the following criteria: Transaction Date Range, Transaction Type, Sales System Reference, Document/Ticket Number, to name a few.

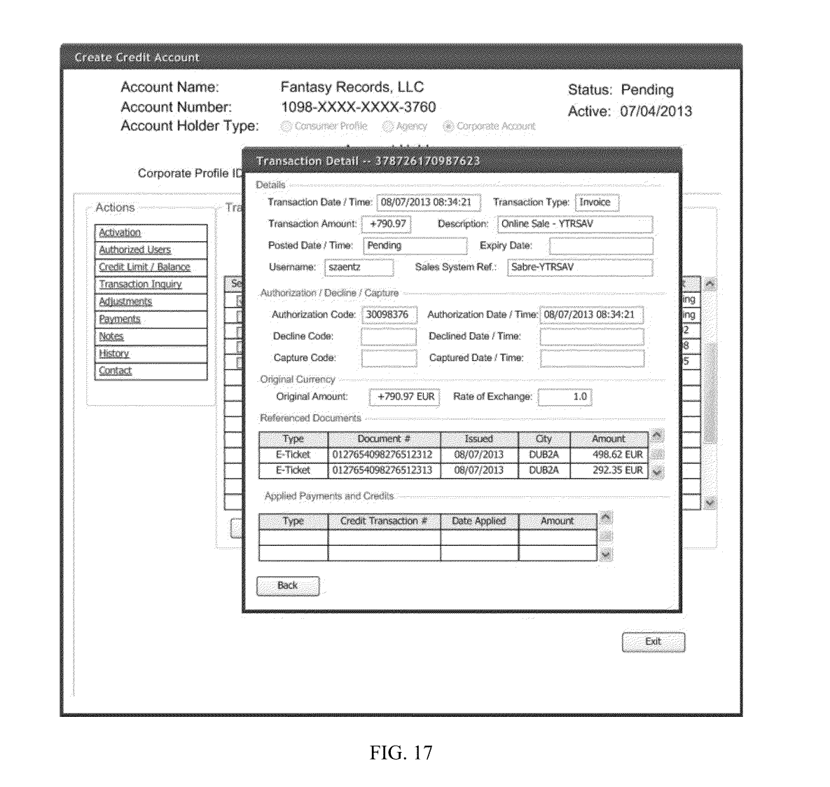

As shown in FIG. 17, in an embodiment, a MUI may comprise a computer program module and/or portions of computer code which enables, facilitates, or otherwise provides for an administrator to use the MUI to select a transaction recorded on one or more databases and display the details of the transaction.

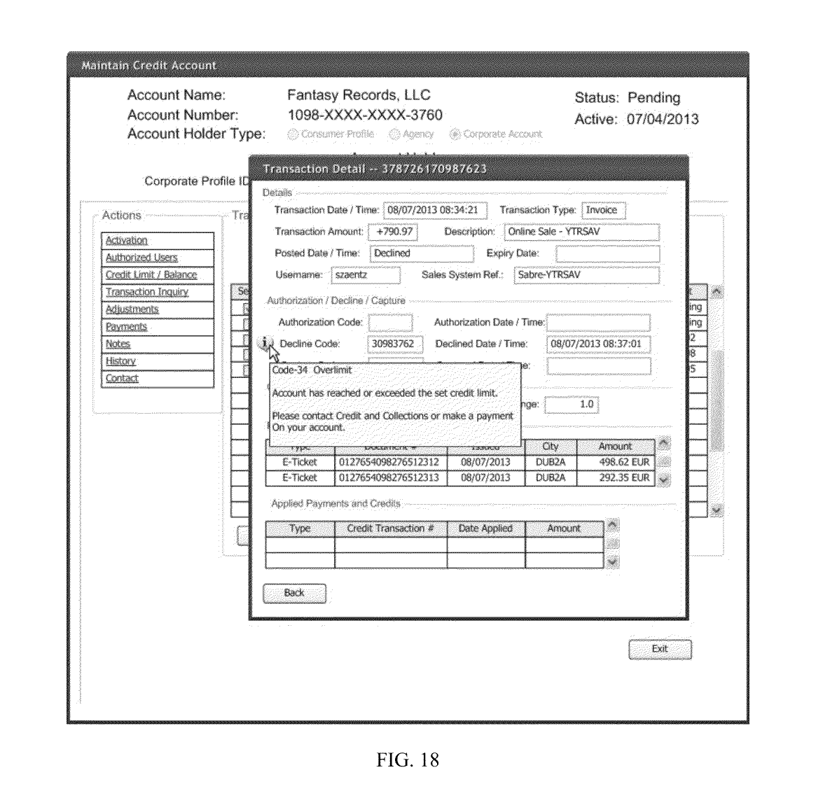

As shown in FIG. 18, in an embodiment, a MUI may comprise a computer program module and/or portions of computer code which enables, facilitates, or otherwise provides for a user to see an “information” icon on a MUI for declined transactions. When he hovers over the icon on the MUI, the reason for the decline may be shown by the MUI.

Make Credit Adjustments

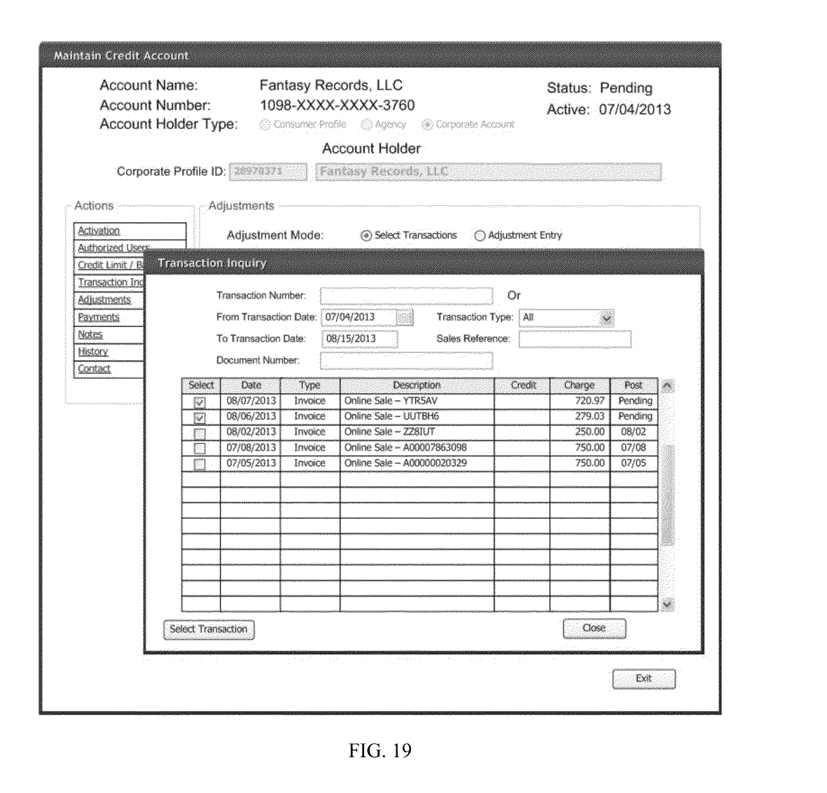

As shown in FIG. 19, the Adjustments section of a MUI may be used to make adjustments to a credit account. In an embodiment, a MUI may comprise a computer program module and/or portions of computer code which enables, facilitates, or otherwise provides for a user to make adjustments to a credit account stored on one or more databases by selecting existing transactions retrieved by a MUI as a reference for the adjustment, or making a general account adjustment, and storing the adjustment to one or more databases.

In an embodiment, a MUI may comprise a computer program module and/or portions of computer code which enables, facilitates, or otherwise provides for a pop-up to be displayed when a Credit Administrator clicks the Adjustment Mode/Select Transactions radio button on a MUI, to allow him to search for transactions to base the adjustment on. In an embodiment, the Credit Administrator may select multiple adjustments, and add them to the selection on a MUI.

In an embodiment, a MUI may comprise a computer program module and/or portions of computer code which enables, facilitates, or otherwise provides for a Credit Administrator to, when all the transaction selections are made, click the “Done” button on a MUI to return to the main adjustment screen and close the pop-up.

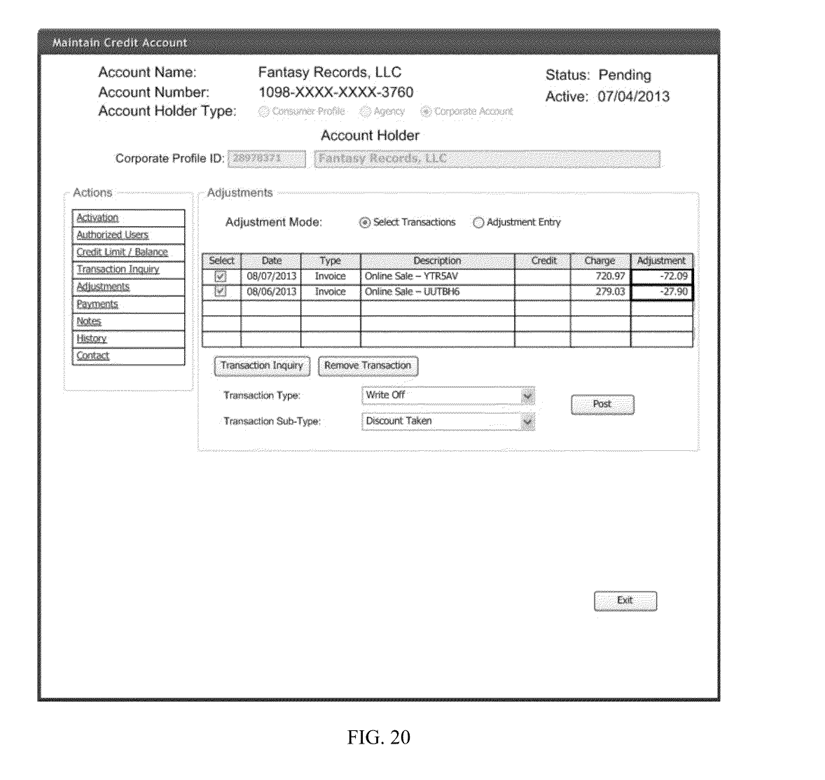

As shown in FIG. 20, in an embodiment, a MUI may comprise a computer program module and/or portions of computer code which enables, facilitates, or otherwise provides for selected transactions to appear on the adjustment page of a MUI showing their original amount allowing the user to modify the original amount (amount of the adjustment) in the same grid row.

In an embodiment, a MUI may comprise a computer program module and/or portions of computer code which enables, facilitates, or otherwise provides for a Credit Administrator to launch the transaction inquiry again by clicking the “Transaction inquiry” button. This allows him to select more transactions into the adjustment screen.

In an embodiment, a MUI may comprise a computer program module and/or portions of computer code which enables, facilitates, or otherwise provides for a user to select the transaction type and sub-type (if any) for the adjustment. The list of which transaction types are displayed in the dropdown box may be controlled by the Credit Administrator's security roles.

In an embodiment, a MUI may comprise a computer program module and/or portions of computer code which enables, facilitates, or otherwise provides for a Credit Administrator, when satisfied with the selected adjustments and after selecting a transaction type, to click the “post” button to process the adjustment transaction and store the selection to one or more databases. The system may create one adjustment transaction for the total amount of the selected adjustments, and apply a reference to each selected transaction in the transaction history as stored on one or more databases.

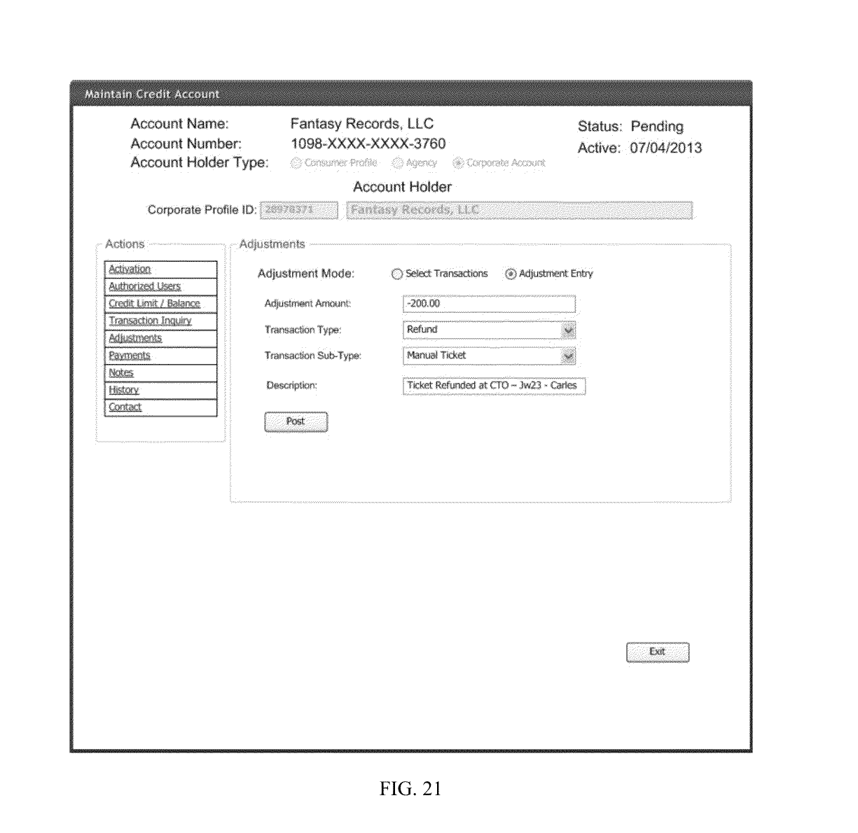

As shown in FIG. 21, in an embodiment, a MUI may comprise a computer program module and/or portions of computer code which enables, facilitates, or otherwise provides for a Credit Administrator to make a general adjusting entry to the account, by selecting the “Adjustment Entry” radio button on a MUI. He may be presented with a form to enter a general adjustment and may direct the MUI to store the entered data linked with an account on one or more databases.

Apply Payments

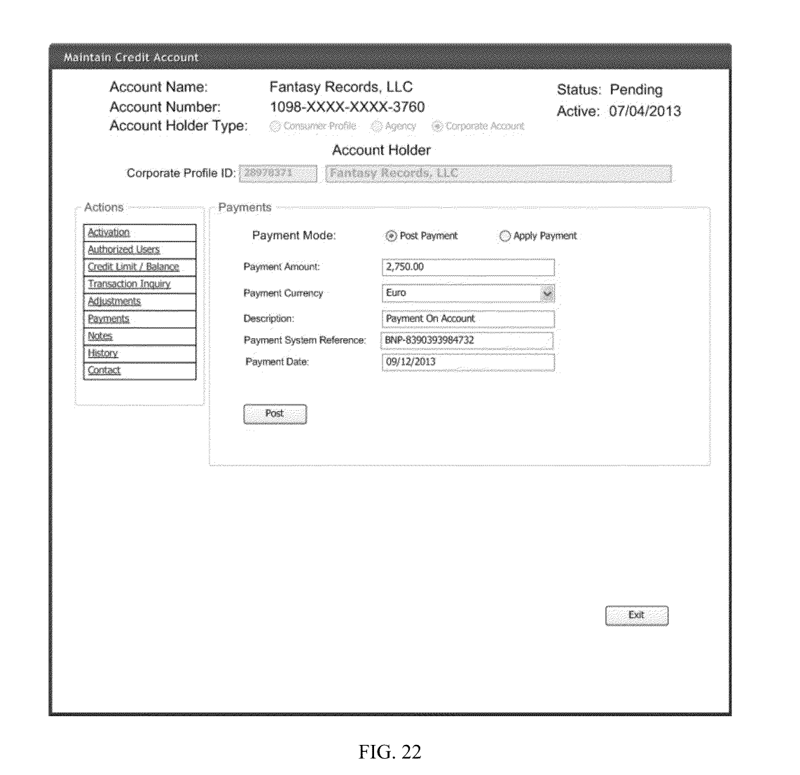

As shown in FIG. 22, in an embodiment, a MUI may comprise a computer program module and/or portions of computer code which enables, facilitates, or otherwise provides for a Payments section which enables a Credit Administrator to post and apply payments to the credit account. In an embodiment, all payments are posted to the credit account initially as a “general payment on account”. This will immediately increase the available balances for the account.

In an embodiment, a MUI may comprise a computer program module and/or portions of computer code which enables, facilitates, or otherwise provides for the Credit Administrator to, once the payment is posted, apply the open payment to any open invoices/charges on the account. In an embodiment, the apply step is optional. It may be used by airlines that want to produce aged balances and statement for their customers, and use receivables ageing for their own analysis.

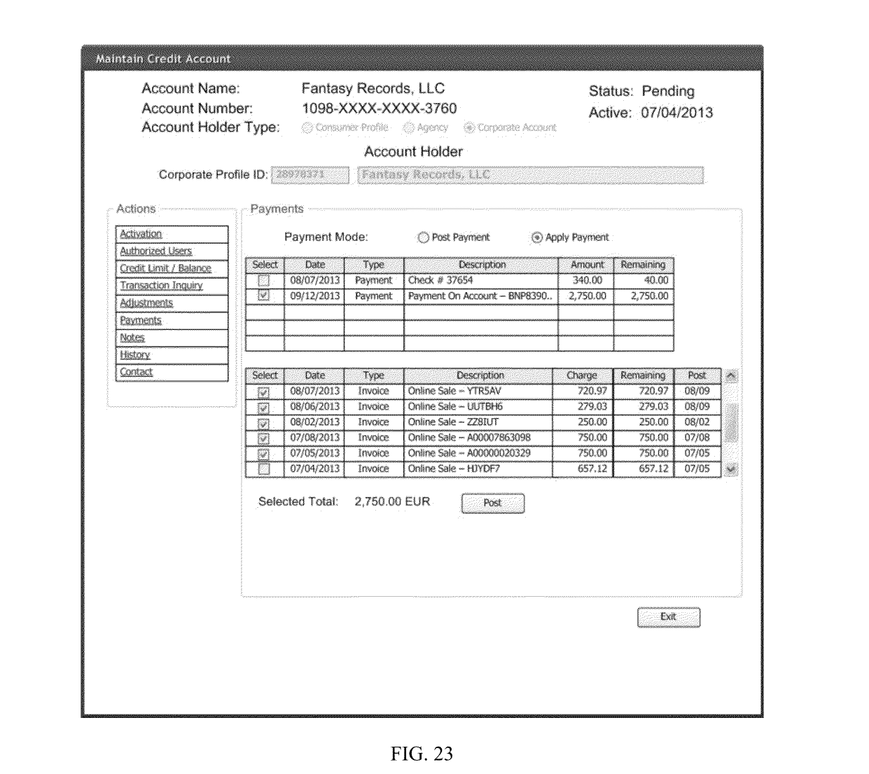

As shown in FIG. 23, in an embodiment, a MUI may comprise a computer program module and/or portions of computer code which enables, facilitates, or otherwise provides for an interface for, e.g., a user to apply an open payment to open invoices. In an embodiment, as the user selects and de-selects invoices, the payment amount may change to equal the sum of the remaining balances of the selected invoice/charge transactions. When the user is satisfied with the payment application, he may click the “Post” button.

In an embodiment, a MUI may comprise a computer program module and/or portions of computer code which enables, facilitates, or otherwise provides for a general credit to the account (payment transaction) to be posted to the account for the total amount, and each selected transaction may be credited for the remaining balance shown.

Maintain and Read Account Notes

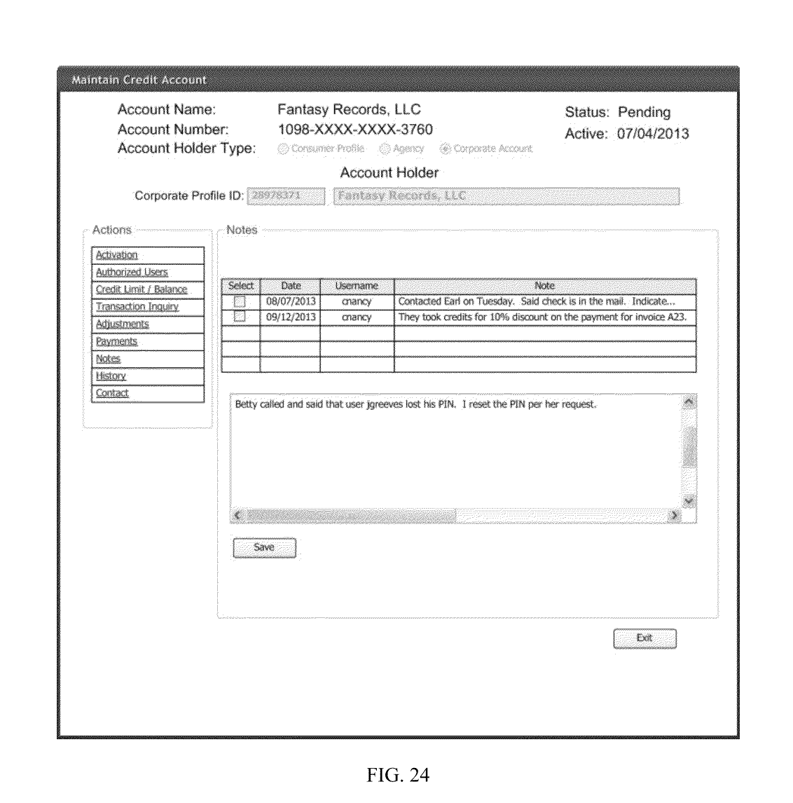

As shown in FIG. 24, in an embodiment, a MUI may comprise a computer program module and/or portions of computer code which enables, facilitates, or otherwise provides for a Notes section to enable a Credit Administrator to add and modify general account level notes to a credit account.

View Access History

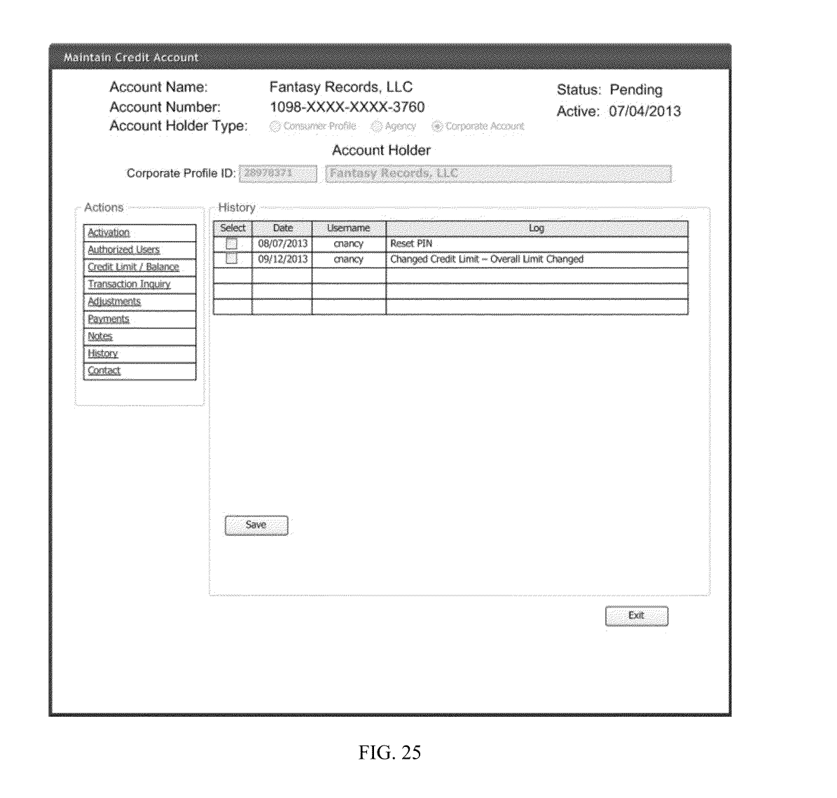

As shown in FIG. 25, in an embodiment, a MUI may comprise a computer program module and/or portions of computer code which enables, facilitates, or otherwise provides for a History section to enable the Credit Administrator to view all account accesses and updates made by Credit Administrators to the account.

Detailed Requirements

Credit Account Management Web Service

The credit account management web services may be used for maintenance operations for a credit account such a creating an account, setting and changing credit limits, closing an account, etc.

The credit account creation and maintenance processes may be implemented as web secure web-services that store and retrieve account data to and from a high availability, secure, and auditable database. The web-services may be utilized by, e.g., a user via a web service interface which may comprise a computer program product and/or computer code running on one or more processors either locally or directed through the Internet, such computer program product and/or computer code configured to enable, facilitate, and/or otherwise provide the input and/or output of data in one or more databases.

Credit Account Access Logging

In an embodiment, the system may comprise a computer program module and/or portions of computer code which enables, facilitates, or otherwise provides for the creation of a log record for each credit account maintenance request serviced by the web service including the following information: Date and time of the operation, the username who performed the operation, the operation such as Created Account, Maintained Credit Limit, etc, a log note describing any special details of the transaction such as “Changed overall limit to $20,000”, to name a few.

The request and response pairs provided are as follows:

Create Account

In an embodiment, the system comprises a computer program module and/or portions of computer code which may perform a web service request that results in the creation, in one or more selected databases, a new credit account, authorized user, and account holder, and/or may link the account to a unique profile identifier from the following types of profile: TDP Customer Profile, TDP Agency Agent Profile (Agency Administrator), TDP Corporate Profile (Corporate Administrator), to name a few.

In an embodiment, the system comprises a computer program module and/or portions of computer code which may auto-generate an account number, such as, for example, a 16 digit modulus 10 credit account number if no account number is passed in the request. The computer program module may direct the storage of the generated account number to one or more selected databases and/or link the generated account number to additional data linked to a user profile.

In an embodiment, the system comprises a computer program module and/or portions of computer code which may require a unique PIN per authorized user when making sales transactions.

In an embodiment, the system comprises a computer program module and/or portions of computer code which may set a currency code for a credit account. In an exemplary embodiment, all transactions against the account must be stored in the currency of the account.

In an embodiment, the system comprises a computer program module and/or portions of computer code which may enforce an overall credit limit for the credit account.

In an embodiment, the system comprises a computer program module and/or portions of computer code which may (optionally) enforce a daily transaction amount limit to a credit account.

In an embodiment, the system comprises a computer program module and/or portions of computer code which may set a terms of payment code for an account that indicates the number of days in which a charge must be paid.

In an embodiment, the system comprises a computer program module and/or portions of computer code which may set a statement closing day of month for a credit account.

In an embodiment, the system comprises a computer program module and/or portions of computer code which may link a credit account to an account holder. In an exemplary embodiment, the account holder must be referenced by a valid login and user profile in TDP.

In an embodiment, the system comprises a computer program module and/or portions of computer code which may store contact information for the account holder.

Retrieve Account

In an embodiment, the system comprises a computer program module and/or portions of computer code which may make a web service request that returns all the details of a given credit account, and optionally an ageing for the account and all transactions.

List Account

In an embodiment, the system comprises a computer program module and/or portions of computer code which may make a web service request to list summary information for a set of credit accounts by the following search criteria: Minimum of 6 digits of the account holder contact telephone number, Account holder contact email address, Account type, Account status, Account authorized username, to name a few.

Maintain Account Holder

In an embodiment, the system comprises a computer program module and/or portions of computer code which may make a web service request that allows the maintenance of the account holder's contact information by, e.g., editing the data linked to the account holder on one or more databases.

Maintain Activation

In an embodiment, the system comprises a computer program module and/or portions of computer code which may make a web service request that sets the status of a credit account. In an exemplary embodiment, the request should support the following operations: Activate a new account on a given future date and with PIN protection, Suspend an account on a given date and time (in an exemplary embodiment, a suspended account will not allow sales (debit) transactions, but will allow payments, adjustments, and credits to be made), Reactivate an account on a given date and time that was previously in suspense, Close an account on a given date and time, to name a few. In an exemplary embodiment, a closed account may not have any transactions posted to it by, e.g., limiting the changes made to specified data linked with a particular account on one or more databases.

List Authorized Users

In an embodiment, the system comprises a computer program module and/or portions of computer code which may make a web service request to list all authorized users for an account by, e.g., accessing and retrieving specified data linked with a particular account on one or more databases.

Maintain Authorized Users

In an embodiment, the system comprises a computer program module and/or portions of computer code which may make a web service request that adds, maintains, and deletes authorized users to an account. In an exemplary embodiment, only authorized users can use a credit account. In an exemplary embodiment, this means they must be logged into TDP through the airline's LDAP (Lightweight Directory Access Protocol) implementation, and their login account must be valid in the authorized users of the credit account.

Add Authorized Users

In an embodiment, the system comprises a computer program module and/or portions of computer code which may add an authorized user to a credit account by, e.g., accessing and editing specified data linked with a particular account on one or more databases. In an exemplary embodiment, the authorized user must have a valid login user name and a valid TDP profile of the following type: TDP Customer Profile, TDP Agency Agent Profile (Agency Administrator), TDP Corporate Profile (Corporate Administrator), TDP Internal User, to name a few.

In an embodiment, the system comprises a computer program module and/or portions of computer code which may auto-generate an account unique 4 digit PIN number for a user and email it to the authorized user. In an exemplary embodiment, the PIN numbers must not be serialized for security reasons.

In an embodiment, the system comprises a computer program module and/or portions of computer code which may add contact information for the authorized user and store it with the credit account linked with that user in one or more databases. In an exemplary embodiment, this information should default to the current profile information if not passed from the caller.

In an embodiment, the system comprises a computer program module and/or portions of computer code which may establish security role codes for an authorized user. The initial roles available are: Use Account—Allows the authorized user to use the account is sales and credit transactions, Maintain Users—Allows the authorized user to add and maintain authorized users, Provide the ability to auto-generate an authorized user account for the account holder, to name a few.

Remove Authorized User

In an embodiment, the system comprises a computer program module and/or portions of computer code which may to remove an authorized user from an account by, e.g., accessing and editing specified data linked with a particular account on one or more databases.

Reset Pin

In an embodiment, the system comprises a computer program module and/or portions of computer code which may reset the PIN number for an authorized user by, e.g., accessing and editing specified data linked with a particular account on one or more databases. In an exemplary embodiment, if the PIN is not passed in the request, auto-generate an account unique 4 digit PIN number for a user and email it to the authorized user. In an exemplary embodiment, the PIN numbers must not be serialized for security reasons.

Link as Customer Contact

In an embodiment, the system comprises a computer program module and/or portions of computer code which may link an authorized user as the account holder by, e.g., accessing and editing specified data linked with a particular account on one or more databases. In an exemplary embodiment, because there can only be one account holder, the existing account holder, if any, must be removed.

Set Credit Terms

In an embodiment, the system comprises a computer program module and/or portions of computer code which may set and change the overall credit limit amount for an account by, e.g., accessing and editing specified data linked with a particular account on one or more databases.

In an embodiment, the system comprises a computer program module and/or portions of computer code which may set and change the daily transaction amount limit for an account by, e.g., accessing and editing specified data linked with a particular account on one or more databases.

In an embodiment, the system comprises a computer program module and/or portions of computer code which may set and change the billing terms code for an account by, e.g., accessing and editing specified data linked with a particular account on one or more databases.

In an embodiment, the system comprises a computer program module and/or portions of computer code which may set and change the statement day of week for an account by, e.g., accessing and editing specified data linked with a particular account on one or more databases.

List Transactions

In an embodiment, the system comprises a computer program module and/or portions of computer code which may make a web service request that returns credit account transactions by the following criteria: Transaction ID, Starting and ending date, Transaction type, Transaction sub-type, Sales reference, Referenced document, Open/Closed status, to name a few.

Maintain Account Notes

In an embodiment, the system comprises a computer program module and/or portions of computer code which may make a web service request that provides the ability to list and maintain credit account notes. Account notes are text notes maintained by credit administrators regarding the account.

Credit Account Transaction Web Service

The credit account transaction web service may be used to process credit transactions such as sales, credits, adjustments, and payments. The web service may be used as a payment authorization gateway in TDP payment transactions and may be implemented as a payment adaptor in TDP. The web-service may be utilized by, e.g., a user via a web service interface which may comprise a computer program product and/or computer code running on one or more processors either locally or directed through the Internet, such computer program product and/or computer code configured to enable, facilitate, and/or otherwise provide the input and/or output of data in one or more databases.

In an exemplary embodiment, the system may comprise a computer program module and/or portions of computer code which enables, facilitates, or otherwise provides for a user logged into TDP, if he is an authorized user for a credit account, the account is not suspended or closed, and there is an available balance on the account, to offer the account as a form of payment in the TDP Consumer, Travel Agency Portal, Corporate portal, and Agent Desktop applications.

In an embodiment, the system may comprise a computer program module and/or portions of computer code which enables, facilitates, or otherwise provides for a sale to be “captured’ as part of the processing of a TDP document service when a credit account is used for payment. The credit account may be used as one of the forms of payment in a ticket or EMD (Electronic Miscellaneous Document) issue command on the host system.

In an embodiment, the system may comprise a computer program module and/or portions of computer code which enables, facilitates, or otherwise provides for all transactions processed by the credit bank transaction web service to be stored securely in the credit bank database.

General Request

According to an exemplary embodiment, the system may comprise a computer program module and/or portions of computer code which enables, facilitates, or otherwise provides for a transaction to be made using a credit account, when the caller supplies the following types of information: Authorized User ID—The logged in user must be an authorized user on the account, Language ID—A valid language ID for TDP (Messages will be returned in this language), Point of Sale—A valid TDP point of sale code, Touchpoint—A valid TDP touchpoint code, Account Number—A valid credit account number, Account PIN—If the account is PIN protected, the PIN of the authorized user must be included for sales transactions, to name a few.

In an embodiment, the system comprises a computer program and/or portions of computer code processed on one or more processors to provide for the following:

Authorize Sale

In an embodiment, the credit bank system comprises a computer program module and/or portions of computer code configured to enable, facilitate, or otherwise provide for a sale to be authorized. In an exemplary embodiment, the credit bank system requires the following to authorize a sale: The credit account number must be valid, The credit account must not be suspended, The credit account must not be closed, The user making the transaction must be a valid authorized user of the account, The user making the transaction must have a “Use Account” role, If the account is PIN protected, the PIN must match that of the authorized user, The amount to authorize must be a positive amount, and Use credit sale for refunds and credits, to name a few.

In an embodiment, the system comprises a computer program module and/or portions of computer code configured to enable, facilitate, or otherwise provide for a currency conversion to be performed if the currency code of the transaction does not match that of the account as recorded on one or more databases. The converted currency amount may be used in checking account balances and the original amount and rate may be stored in the transaction.

In an exemplary embodiment, the available balance amount must be greater than or equal to the amount of the requested sale for the system to complete the sale transaction.

In an exemplary embodiment, the available daily balance must be greater than or equal to the requested sales amount for the system to complete the sale transaction.

Decline

In an exemplary embodiment, the system comprises a computer program module and/or portions of computer code configured to decline the authorization if any of the previous rules are not met. The transaction may be written to the credit account database with a: Declined Code—A sequential number within the system day (date) for declines, Date and Time—The date and time of the decline, Decline Reason Code—A unique code valid in a system decline reason code file that relates to the reasons for the decline, Decline Message—A text message in the requested language explaining the decline, Decline Language—A code for the language of the decline.

In an embodiment, the transaction may be written to the database with a disposition of voided. In another embodiment, the system comprises a computer program module and/or portions of computer code configured to return the decline information to the client.

Authorize

In an exemplary embodiment, the system comprises a computer program module and/or portions of computer code configured to grant the authorization if all of the previous rules are met. In an embodiment, the system comprises a computer program module and/or portions of computer code configured to return to the caller an authorization code and date and record an authorization transaction to the credit account database. An authorization may place a temporary hold on funds in the account for the amount authorized and this amount may become part of pending account balances. The transaction may contain the following authorization attributes: Authorization Code—A sequential number within the system day (date) for authorizations, Date and Time—The date and time of the authorization, Date—The date (only) portion that forms the unique key with the authorization code (this is the date for the sequence of authorization numbers issued), Expires date Time—The date and time at which the authorization will be voided and funds held are returned to the account (the duration used to set this date may be a system configuration.

In an embodiment, the system comprises a computer program module and/or portions of computer code configured to write the transaction to one or more databases with no disposition. In an embodiment, the system comprises a computer program module and/or portions of computer code configured to return the authorization information to the client via, e.g., an email communication. The client may keep track of the authorization date and code as these values must be used in the capture transaction.

In an embodiment, the system comprises a computer program module and/or portions of computer code configured such that the transaction does not have a general ledger journal effect.

Return Response

In an embodiment, the system comprises a computer program module and/or portions of computer code configured to return the authorized or declined information to the client via, e.g., an email communication.

Calculating Available Balances

In an embodiment, the system comprises a computer program module and/or portions of computer code configured to return the available balances and pending amounts for a credit account whenever the credit account is retrieved or listed. In an exemplary embodiment, the system comprises a computer program module and/or portions of computer code configured to enable, facilitate or otherwise provide for retrieval and list services to calculate the available balance, available daily balance, and pending transactions using the following logic:

Retrieve the record from the transaction summary table. This contains a total of all posted credits and debits to the account. Add the debits and credits. (Posted Transactions)

Retrieve all transactions with no disposition (not voided, not posted) that are authorized, and whose authorization expiration date and time are greater than the system date and time. Sum the transaction amounts. (Pending Amount)

Retrieve all transactions that were posted between 00:00:01 and 23:59:59 of the system date. Sum the amounts and add the Pending Amount. (Daily Transactions)

Available Balance=Overall Credit Limit Amount−(Posted Transactions+Pending Amount)

Available Daily Balance=Daily Transaction Limit Amount−(Daily Transactions+Pending Transactions)

Pending Transactions=Pending Transactions

Capture Sale

In an exemplary embodiment, the system comprises a computer program module and/or portions of computer code configured to enable, facilitate or otherwise provide for capture of a sale and the creation ofa permanent posted transaction in, e.g., the credit account database. In an embodiment, the system comprises a computer program module and/or portions of computer code configured to enable, facilitate or otherwise provide for a capture to be performed as the result of the issuance of a document, e.g., an air ticket or EMD, and can be implemented as part of a Reservation Document transaction.

In an embodiment, the system comprises a computer program module and/or portions of computer code configured to enable, facilitate or otherwise provide for a client to call to capture a sale using a previously obtained authorization date and code, or to capture without a previous authorization. In an exemplary embodiment, the following common rules must be met:

The credit account number must be valid;

The credit account must not be suspended;

The credit account must not be closed;

The user making the transaction must be a valid authorized user of the account;

The user making the transaction must have a “Use Account” role;

If the account is PIN protected, the PIN must match that of the authorized user; and

The amount to authorize must be a positive amount. Use credit sale for refunds and credits.

In an embodiment, the system comprises a computer program module and/or portions of computer code configured to enable, facilitate or otherwise provide for a currency conversion to be performed if the currency code of the transaction does not match that of the account. In an embodiment, the converted currency amount is used in checking account balances and the original amount and rate are stored in the transaction.

Capture with Authorization

In an embodiment, the system comprises a computer program module and/or portions of computer code configured to enable, facilitate or otherwise provide for the retrieval of the original transaction record created in the authorization by using the authorization date and code when capturing a sale with an authorization date and code previously obtained. In an exemplary embodiment, the following validations are made:

In an embodiment, the system comprises a computer program module and/or portions of computer code configured to treat the capture as failed and roll back the transaction if these validations are not found.

In an embodiment, the system comprises a computer program module and/or portions of computer code configured to check the expiration date of the authorization if the transaction is retrieved. In an embodiment, the system comprises a computer program module and/or portions of computer code configured to treat the capture as failed and roll back the transaction if the system date/time is greater than the authorization expiration date/time.

In an embodiment, the system comprises a computer program module and/or portions of computer code configured to update the transaction record from its prior state as entered into one or more databases when created at authorization, if the validation above passes.

In an embodiment, the system comprises a computer program module and/or portions of computer code configured to update the transaction record from its prior state as entered into one or more databases when created at authorization to add to the transaction any referenced documents that are in the request and/or.

In an embodiment, the system comprises a computer program module and/or portions of computer code configured to update the transaction record from its prior state as entered into one or more databases when created at authorization to add to the transaction any transaction description or sub-type given in the request.

In an embodiment, the system comprises a computer program module and/or portions of computer code configured to process common database handling when, .e.g., updating transaction records on one or more databases.

Capture without Authorization

In an embodiment, the system comprises a computer program module and/or portions of computer code configured to enable, facilitate or otherwise provide for the insertion of a new transaction record into one or more databases when capture is performed without prior authorization. In an exemplary embodiment, the system comprises a computer program module and/or portions of computer code configured to require validation of all of the common rules.

In an embodiment, the system comprises a computer program module and/or portions of computer code configured to enable, facilitate or otherwise provide for the amount to be captured to be checked against the account balances as described in authorize sale, that is:

The available balance amount must be greater than or equal to the amount of the requested sale.

The available daily balance must be greater than or equal to the requested sales amount.

In an embodiment, the system comprises a computer program module and/or portions of computer code configured to enable, facilitate or otherwise provide for the database insert to be formatted on one or more databases if the validation above is passed.

In an exemplary embodiment, the system comprises a computer program module and/or portions of computer code configured to enable, facilitate or otherwise provide for any referenced documents that are in the request to be added to the transaction on one or more databases.

In an exemplary embodiment, the system comprises a computer program module and/or portions of computer code configured to enable, facilitate or otherwise provide for any transaction description or sub-type given in the request to be updated in the transaction on one or more databases.

In an embodiment, the system comprises a computer program module and/or portions of computer code configured to process common database handling when, e.g., updating transaction records on one or more databases.

Return Response

In an embodiment, the system comprises a computer program module and/or portions of computer code configured to enable, facilitate or otherwise provide for the return of the capture code and date via, e.g., display of the data on a user interface.

Common Database Handling

In an exemplary embodiment, the system comprises a computer program module and/or portions of computer code configured to enable, facilitate or otherwise provide for the update of the database or databases, if all validation is met for the transaction, in one commitment boundary as follows:

A capture code, which is an account unique sequence should be updated into the transaction.

The capture date/time should be set to system date/time.

The disposition transaction posted date/time should be set to system date/time.

The transaction summary table should be updated with the transaction.

The database transaction should be committed.

Credit Sale

In an embodiment, the system comprises a computer program module and/or portions of computer code configured to enable, facilitate or otherwise provide for a credit sale to be used to refund or credit a user for, e.g., purchases via measures such as, but not limited to, residual ticket values, etc. When the airline issues a credit, it may have an expiration date. In an embodiment, the system comprises a computer program module and/or portions of computer code configured to enable, facilitate or otherwise provide for the evaluation of an expiration date of an, e.g., airline credit by means of accessing data linked to an account on one or more databases and/or disallowing the expired credit to be applied as a form of payment for sales transactions. In an embodiment, the system comprises a computer program module and/or portions of computer code configured to enable, facilitate or otherwise provide for a nightly process which, when the credit expires, generates an adjusting transaction to debit the amount of the credit as recorded on one or more databases. In an embodiment, the system comprises a computer program module and/or portions of computer code configured to enable, facilitate or otherwise provide for the credit expiration date to be set based on a value found in the transaction type table for the transaction type CreditSale.

In an embodiment, the system comprises a computer program module and/or portions of computer code configured to enable, facilitate or otherwise provide for a credit sale service request which may be used by a Reservation Document adaptor when the airline allows refunded or residual exchange amounts to be credited to the credit account.

In an exemplary embodiment, the system comprises a computer program module and/or portions of computer code configured to enable, facilitate or otherwise provide for the following validations to be performed for a credit sale:

The credit account number must be valid;

The credit account must not be closed;

The user making the transaction must be a valid authorized user of the account;

The user making the transaction must have a “Use Account” role; and

The amount to authorize must be a negative amount.

In an embodiment, the system comprises a computer program module and/or portions of computer code configured to enable, facilitate or otherwise provide for a currency conversion to be performed if the currency code of the transaction does not match that of the account. In an embodiment, the system comprises a computer program module and/or portions of computer code configured to enable, facilitate or otherwise provide for the original amount and rate to be stored in the transaction.

In an embodiment, the system comprises a computer program module and/or portions of computer code configured to process common database handling when, e.g., updating transaction records on one or more databases.

Void Authorized Sale

In an embodiment, the system comprises a computer program module and/or portions of computer code configured to enable, facilitate or otherwise provide for a void authorized sale transaction to void a sale that was authorized, but not captured. This transaction can be used by Reservation Payment services that might need to rollback an authorization.

In an exemplary embodiment, the system comprises a computer program module and/or portions of computer code configured to enable, facilitate or otherwise provide for the following validations to be performed for a void authorized sale transaction:

The credit account number must be valid; and

The credit account must not be closed.

In an embodiment, the system comprises a computer program module and/or portions of computer code configured to enable, facilitate or otherwise provide for a requirement that the user making the transaction must be a valid authorized user of the account.

In an embodiment, the system comprises a computer program module and/or portions of computer code configured to enable, facilitate or otherwise provide for a requirement that the user making the transaction must have a “Use Account” role.

In an embodiment, the system comprises a computer program module and/or portions of computer code configured to enable, facilitate or otherwise provide for the system to retrieve the original transaction record created in the authorization by using the authorization date and code when voiding a sale with an authorization date and code previously obtained. In an exemplary embodiment, the system comprises a computer product module and/or portions of computer code configured to enable, facilitate or otherwise provide for the following validations to be made:

If not found, the void should fail and the transaction should be rolled back.

If found, the transaction must not have any disposition (voided or posted)

If the transaction is found and has no disposition, a transaction voided date/time disposition should be added and the transaction should be updated.

In an embodiment, the system comprises a computer program module and/or portions of computer code configured such that the transaction does not have a general ledger journal effect.

Make Adjustment

In an embodiment, the system comprises a computer program module and/or portions of computer code configured to enable, facilitate or otherwise provide for a make adjustment request, which may be used by the credit administrator to adjust balances of the account. In an embodiment, the make adjustment request is not a consumer user action and does not require a PIN, and the system comprises a computer program module and/or portions of computer code configured to enable, facilitate or otherwise provide for a requirement that the user is an administrative user that has system level role that allows him to make adjustments. In an embodiment, the system comprises a computer program module and/or portions of computer code configured to enable, facilitate or otherwise provide for the system level role to be controlled at the UI (User Interface) level.

In an exemplary embodiment, the major transaction type for the make adjustment request is always “Adjustment”. A transaction sub-type may be included as this indicates the kind of adjustment to be made. For example, “WriteOffSale”, “ExtendCreditExpiry”, “ReturnedCheck” etc.

In an embodiment, the system comprises a computer program module and/or portions of computer code configured to enable, facilitate or otherwise provide for one or more referenced transactions to be included, e.g., to allocate the adjustment amount over multiple referenced transactions.

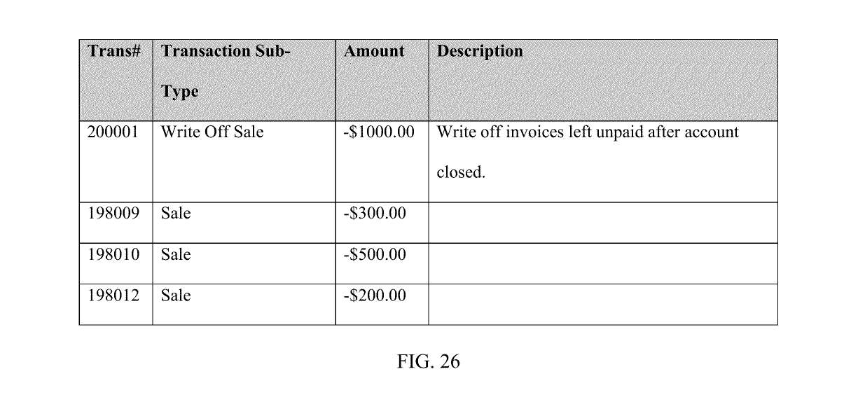

In the example shown in FIG. 26, the user has selected three sales to write off in the amount of −$1000.00. In an embodiment, the system comprises a computer program module and/or portions of computer code configured to process the user request using the following processing steps:

Create a new transaction (200001) that credits the account for $1000.00; and

Update three transactions with a reference to 200001 and the allocated amount as shown.

In an embodiment, the system comprises a computer program module and/or portions of computer code configured to enable, facilitate or otherwise provide for the following validations to be performed for a make adjustment transaction:

The credit account number must be valid; and

The credit account must not be closed.

In an embodiment, the system comprises a computer program module and/or portions of computer code configured to enable, facilitate or otherwise provide for a requirement that, if referenced transactions are included, they must exist in the DB (Database).

In an embodiment, the system comprises a computer program module and/or portions of computer code configured to enable, facilitate or otherwise provide for a requirement that, if referenced transactions are included, the total of the referenced transactions must equal the total of the adjustment transaction amount.

In an embodiment, the system comprises a computer program module and/or portions of computer code configured to enable, facilitate or otherwise provide for the following database processing to be performed:

Insert a new transaction using the transaction type “Adjustment” and the transaction sub-type passed by the client;

Insert referenced transactions passed by the client;

Set the disposition transaction posted date/time to system date/time;

Update the transaction summary table with the transaction; and

Commit the database transaction.

Return Response

In an embodiment, the system comprises a computer program module and/or portions of computer code configured to return the credit account summary to the user via, e.g., display of the data on a user interface.

Post Payment

In an embodiment, the system comprises a computer program module and/or portions of computer code configured to enable, facilitate or otherwise provide for a post payment request to be used by the credit administrator to post a payment to a credit account. In an embodiment, the make adjustment request is not a consumer user action and does not require a PIN, and the system comprises a computer program module and/or portions of computer code configured to enable, facilitate or otherwise provide for a requirement that the user is an administrative user that has system level role that allows him to make adjustments. In an embodiment, the system comprises a computer program module and/or portions of computer code configured to enable, facilitate or otherwise provide for the system level role to be controlled at the UI level.

In an embodiment, the major transaction type for this post payment transaction may be “PostPayment”. A transaction sub-type may be included for the transaction. For example, “PrePayment” or “BankOne”, etc.

In an embodiment, the system comprises a computer program module and/or portions of computer code configured to enable, facilitate or otherwise provide for the following validations to be performed for a post payment transaction:

The credit account number must be valid; and

The credit account must not be closed.

In an embodiment, the system comprises a computer program module and/or portions of computer code configured to enable, facilitate or otherwise provide for a requirement that a client system reference be entered. In an embodiment, this client system reference is a check number or a remote system wire transfer number.

In an embodiment, the system comprises a computer program module and/or portions of computer code configured to enable, facilitate or otherwise provide for the following database processing to be performed:

Insert a new transaction using the transaction type “PostPayment” and the transaction sub-type passed by the client.

The disposition transaction posted date/time should be set to system date/time.

The transaction summary table should be updated with the transaction.

The database transaction should be committed.

Return Response

In an embodiment, the system comprises a computer program module and/or portions of computer code configured to return the credit account summary to the user via, e.g., display of the data on a user interface.

Apply Payment

In an embodiment, the system comprises a computer program module and/or portions of computer code configured to enable, facilitate or otherwise provide for an apply payment request to be used by the credit administrator to apply a previously posted payment to selected sale transactions. In an embodiment, the system comprises a computer program module and/or portions of computer code configured to enable, facilitate or otherwise provide for the transaction to have no effect on the general ledger, as it only serves to cross-reference a general payment to a set of charges.

In an embodiment, the make adjustment request is not a consumer user action and does not require a PIN, and the system comprises a computer program module and/or portions of computer code configured to enable, facilitate or otherwise provide for a requirement that the user is an administrative user that has system level role that allows him to make adjustments. In an embodiment, the system comprises a computer program module and/or portions of computer code configured to enable, facilitate or otherwise provide for the system level role to be controlled at the UI level.

In an exemplary embodiment, no new transactions are written when applying payments, so transaction type and sub-type are not needed.

In an embodiment, the system comprises a computer program module and/or portions of computer code configured to enable, facilitate or otherwise provide for the following validations to be performed for a post payment transaction:

The credit account number must be valid; and

The credit account must not be closed.

In an embodiment, the system comprises a computer program module and/or portions of computer code configured to enable, facilitate or otherwise provide for a requirement that the payment transaction referenced by the payment transaction ID exist and be of type “PostPayment”.

In an embodiment, the system comprises a computer program module and/or portions of computer code configured to enable, facilitate or otherwise provide for a requirement that the transactions referenced by reference transaction ID exist and be posted.

In an embodiment, the system comprises a computer program module and/or portions of computer code configured to enable, facilitate or otherwise provide for a requirement that the transactions referenced by the reference transaction ID be of type “Sale” or “Adjustment” transaction type.

In an embodiment, the system comprises a computer program module and/or portions of computer code configured to enable, facilitate or otherwise provide for a requirement that the transactions referenced by the reference transaction ID of type sale or adjustment must not have a closed date.

In an embodiment, the system comprises a computer program module and/or portions of computer code configured to enable, facilitate or otherwise provide for a requirement that the total of the referenced transactions plus any existing reference transactions for the payment must not exceed the payment posted amount.

In an embodiment, the system comprises a computer program module and/or portions of computer code configured to enable, facilitate or otherwise provide for the following database processing to be performed:

Insert reference transactions for each referenced transaction element passed by the client under the referenced payment transaction. These references should have transaction type of “Sale” and the amount should be the amount applied.

Insert a reference transaction for each referenced transaction element passed by the client under the referenced transaction. These references should have transaction type of “Payment” and the amount should be the amount applied.

When the total of payments applied to a sales or adjustment transaction equal the sales amount, the disposition closed date/time should updated with the system date/time.

The database transaction should be committed.

Return Response

In an embodiment, the system comprises a computer program module and/or portions of computer code configured to return the credit account summary to the user via, e.g., display of the data on a user interface.

Journal Posting

In an embodiment, the system comprises a computer program module and/or portions of computer code configured to enable, facilitate or otherwise provide for a journal posting service request which may form a two part process that interfaces credit bank transactions to the airline's financial system. In an exemplary embodiment, the two steps are:

Create G/L Journals—Write balanced G/L journals to the credit bank database with a null posted date/time; and

Post G/L Journals—Transmit G/L journals to the airline's financial system in detail or summary and update the posted date/time in the credit bank journal table.

Create G/L Journals

In an embodiment, the system comprises a computer program module and/or portions of computer code configured to enable, facilitate or otherwise provide for this web service request to create balanced G/L journals for a set of selected credit bank transactions passed by the client. In an embodiment, the system comprises a computer program module and/or portions of computer code configured to enable, facilitate or otherwise provide for the user and/or client to call create journals on a real-time basis after the credit bank transaction is committed, or as a customized batch process that selects a set of credit bank transactions based on transaction date.

In an embodiment, TDP may provide a real-time creation of journals as part of the credit bank transaction processing.

In an exemplary embodiment, the system comprises a computer program module and/or portions of computer code configured to enable, facilitate or otherwise provide for the G/L Journalsto be balanced. This means that for every credit bank transaction posted, there must be at least two journals produced, a debit and a credit. The account ledger keys to use in the posting may be obtained by looking up the configuration of ledger keys in Transaction Type and Sub-Type master tables from one or more databases.

In an embodiment, the system comprises a computer program module and/or portions of computer code configured to enable, facilitate or otherwise provide for any special journaling required by the airline to be accomplished by interfacing an intermediate response (before writing journals to the database) to a Business Rules Engine. In an embodiment, the intermediate interface may look like the create G/L journals response message.

Processing

In an embodiment, the system comprises a computer program module and/or portions of computer code configured to enable, facilitate or otherwise provide for each transaction passed in the request to comprise the following steps:

Lookup transaction type and sub-type to obtain the ledger keys for the balanced transaction;

Create intermediate journal entries for the transaction;

Call Business Rules Engine; and

Insert journal entries into the credit bank database with a null posted date, to name a few.

Return Response

In an embodiment, the system comprises a computer program module and/or portions of computer code configured to return the create G/L journals response to the user via, e.g., display of the data on a user interface.

Post G/L Journals

In an embodiment, the system comprises a computer program module and/or portions of computer code configured to enable, facilitate or otherwise provide for a web service request to take all un-posted credit bank journals, (optionally) summarize the journals by ledger key, and transmit the results to the airline's G/L system. In an embodiment, the service is be written as an adaptor resolving service and a handler should be built for each airline's unique G/L system.

In an embodiment, the system comprises a computer program module and/or portions of computer code configured to enable, facilitate or otherwise provide for a default adaptor to produce an Excel spreadsheet with the journal details by account and a summary total for each ledger key account. The file may be written to a local drive/directory on the server per a configured value.

In an embodiment, the system comprises a computer program module and/or portions of computer code configured to enable, facilitate or otherwise provide for a credit bank journal file to then be updated with a posted date/time for all journals posted.

Ageing

In an embodiment, the system comprises a computer program module and/or portions of computer code configured to enable, facilitate or otherwise provide for the creation of an ageing element when a credit account is retrieved in summary or detail, which gives a breakdown of balances due by aged period. In an embodiment, the aged periods may be set by configuration. In an embodiment, the default periods may be:

Zero to 30 Days

31 to 60 Days

61 to 90 Days

Over 90 Days

In an embodiment, the system comprises a computer program module and/or portions of computer code configured to enable, facilitate or otherwise provide for the creation of an ageing comprising the following steps for each aged period:

Select all transactions posted within that period. The system date+the period start number of days with a time of 00:00:00:001 should be used as the start. Add the period duration in days to the start to get the end of the aged period.

Sum all transaction amounts for this period and return the amount.

Nightly Process

In an embodiment, the system comprises a computer program module and/or portions of computer code configured to enable, facilitate or otherwise provide for a nightly process to perform account housekeeping. In an embodiment, the process may be scheduled to run after midnight each night. In an embodiment, the system comprises a computer program module and/or portions of computer code configured to enable, facilitate or otherwise provide for a process which perfoms the following:

Void Expired Authorizations—All authorizations whose expiry date has passed with no capture date, posted date, or void date should be updated as voided.

Make Adjustments for Expired Credits—Credits issued for refunded tickets and other document redemptions can have expiry dates. The system may select all “Credit” type transactions where the expiry date and time has passed and there is no referenced reversing transaction. For each of these transactions, the system may call Make Adjustment to create an adjustment transaction to debit the amount of the original credit.

Re-roll Transaction Summary—The Transaction summary table may be updated with the total debits and credits posted on a nightly basis to ensure accuracy.

Reconciliation

In an embodiment, the system comprises a computer program module and/or portions of computer code configured to enable, facilitate or otherwise provide for a reconciliation process between the airline ticketing system and TDP, since credit transactions like refunds and exchanges of tickets and EMDs that used a credit account as an original ticket form of payment can occur outside of TDP.

In an embodiment, the system comprises a computer program module and/or portions of computer code configured to enable, facilitate or otherwise provide for a process by which TDP may receive and reconcile the standard ASR (Agent Sales Report) produced for the airline's revenue management system. In an embodiment, the process may filter to select only transactions with a credit bank form of payment type.

In an embodiment, the system comprises a computer program module and/or portions of computer code configured to enable, facilitate or otherwise provide for the system to locate the corresponding journal for each of the credit bank transactions on the ASR by referenced document number and reconcile the amount. In an embodiment, any transactions not matched may be added to an adjustment report.

Reporting

In an embodiment, the system comprises a computer program module and/or portions of computer code configured to enable, facilitate or otherwise provide for a reporting module that supplies critical management reports for credit administrators and monthly statements for customers. In an embodiment, the reports may be accessible from a management user interface and be capable of being run on demand.

In an embodiment, reports may be capable of being output to Adobe PDF format and/or Microsoft Excel spreadsheets. In an embodiment, reports may be capable of being emailed to the account contact, or any email address.

Monthly Statements

In an embodiment, the system comprises a computer program module and/or portions of computer code configured to enable, facilitate or otherwise provide for a monthly statement that lists all charges, payments, credits and adjustments for a credit account for a given timeframe. In an embodiment, the default timeframe may be one month. In an embodiment, an account ageing may be shown at the bottom of the statement. In an embodiment, the statement may use the default address information in the airline POS (Point of Sale) and include an airline logo.

In an embodiment, the statement can be run on demand for any given accounting period, or can be run in batches using a scheduled job.

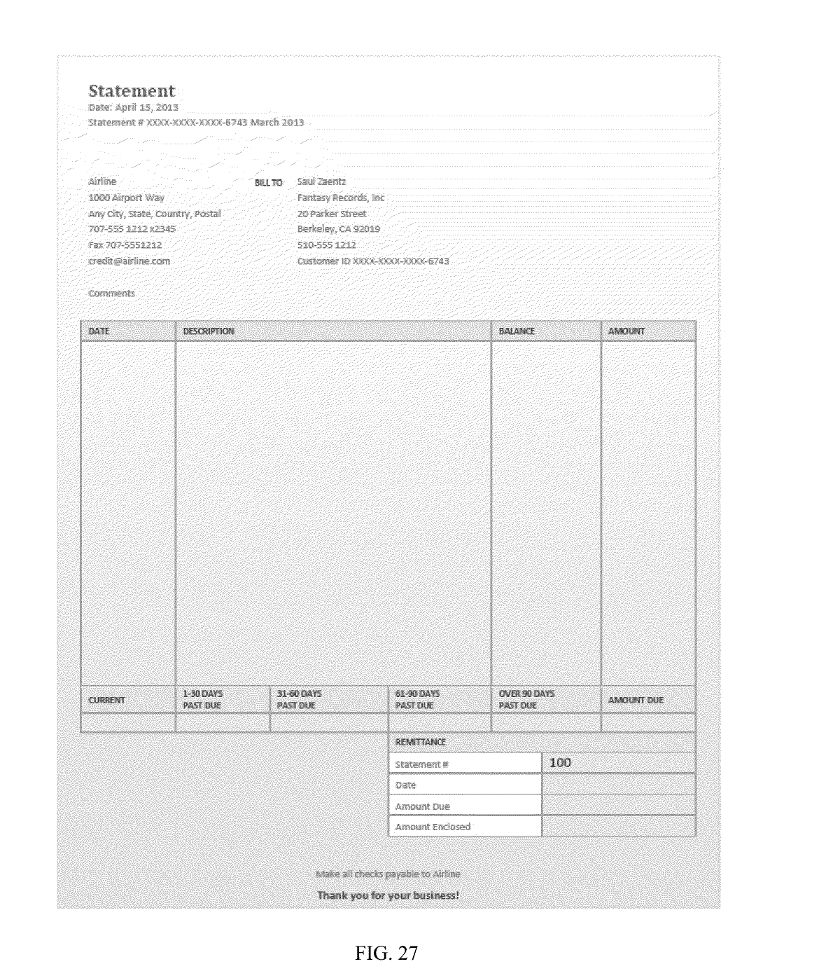

FIG. 27 shows the format of the statement according to an exemplary embodiment of the present invention.

Aged Balances by Customer Account

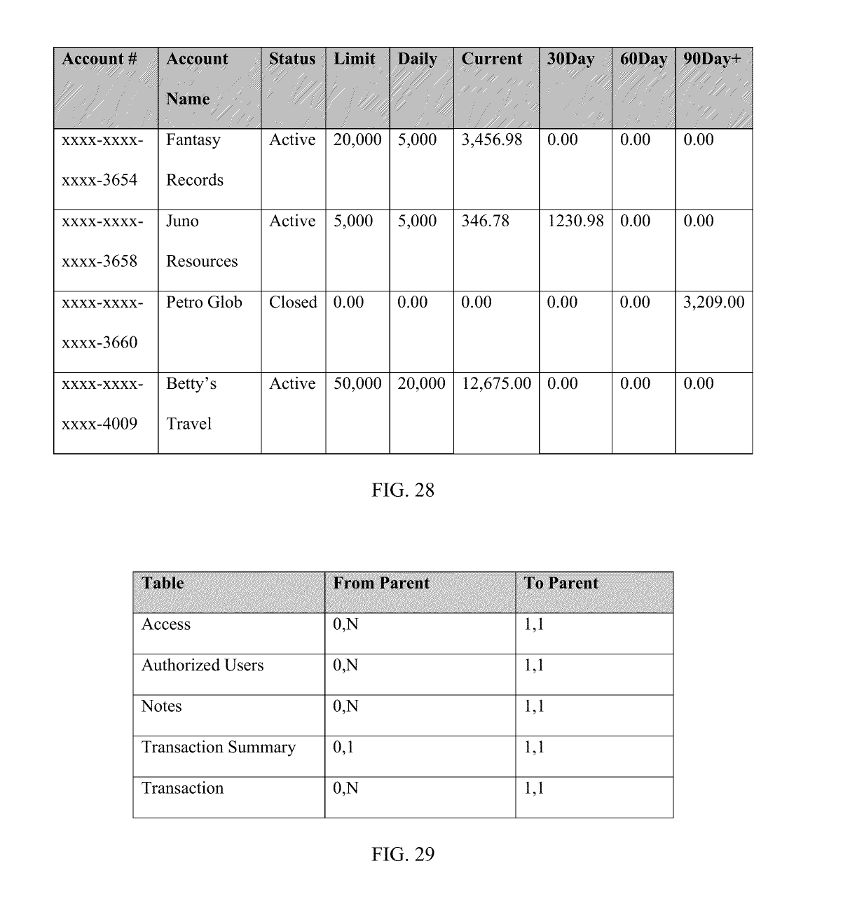

The aged balances by customer account report may show a list of customers of the airline and their current credit account balances, limit, and daily limit. It may also include an ageing. FIG. 28 shows the format of an aged balances by customer account report according to an exemplary embodiment of the present invention.

Aged Balance Exceptions by Customer Account

In an embodiment, the system comprises a computer program module and/or portions of computer code configured to enable, facilitate or otherwise provide for an aged balance exceptions report that has the same format as the aged balances by customer account, but only include accounts that fit a set of exception filters selected by the credit manager on demand. In an embodiment, the filters may include the following criteria:

Select Account Status—filter account statuses (multiple select)

Percentage of Credit Limit—Select account if the charges are equal to or greater than the set percentage of the credit limit, example 90% of credit limit

Percentage of Daily Limit—Select account if the charges are equal to or greater than the set percentage of the daily transaction limit

Period Balance Exceeds—Select account if the selected period balance exceeds a selected amount. For example, 90 Days>$555.00

Transaction Export

In an embodiment, the system comprises a computer program module and/or portions of computer code configured to enable, facilitate or otherwise provide for a transaction export report that extracts a csv or xls file of all transactions on a specific account or all accounts for a given date range. In an embodiment, the extract may include all attributes of a transaction except referenced transactions. In an embodiment, referenced documents may show the first 4 documents listed in a column like Document 1, Document 2, etc.

Daily Journal Report

In an embodiment, the system comprises a computer program module and/or portions of computer code configured to enable, facilitate or otherwise provide for a daily journal report that lists all journals produced for credit transactions for a given date range. In an embodiment, the default may be a one day period. In an embodiment, the journals may be listed by journal entry number and journal sequence within the journal entry number. In an embodiment, the output may be a csv or xls file.

Credit Bank Database

In an embodiment, the Credit Bank database 24 may store credit accounts and transactions. The database 24 may be highly reliable, and secure. In exemplary embodiments in which the Credit Bank 24 and credit management component 10 are independent modules of TDP, it may be necessary to create a new schema for the database.

In an embodiment, the Credit Bank 24 may incorporate Oracle security as well as service level security and Oracle auditing.

In an embodiment, the Credit Bank 24 database model may be very simple, and relate closely to the object model of Credit Bank 24. Web services comprising, e.g., computer program or portions of computer code may make all updates to the database, and there may be no client server access.

The following describes the tables to be included in a Credit Bank 24 database model according to an exemplary embodiment of the present invention. Column data may be excluded as it can be inherited from the object model.

Credit Account

A credit account may be used to grant and track credits and credit sales made by consumers, agencies, and corporate customers of the Airline. The credit account table may not be of significant size (less than 1 million rows).

Account Number

A credit account may be uniquely keyed by an account number. The account number can be passed in the service at account creation or, if not passed, may be auto-generated by TDP. The account number may be stored in encrypted form and may be masked to the last four digits of the account.

Account numbers generated by TDP may be the same length as a Visa credit card number and may be generated with a Mod10 check digit. This is so that the credit account can pass Mod10 checks done by the airline CRS systems during ticketing.

Account Holder

A credit account may be created with one and only one account holder. The account holder may be a valid user profile holder. The profile may be that of a Consumer Profile, a Travel Agency Agent, or a Corporate Account Administrator. The account holder may be changed via a web service.

In an embodiment, the contact information for the account holder may be changed from that of the profile and may be stored in the credit account table.

Child Tables

FIG. 29 show child tables that may be associated with a credit account according to an exemplary embodiment of the present invention.

Alternate Indexes

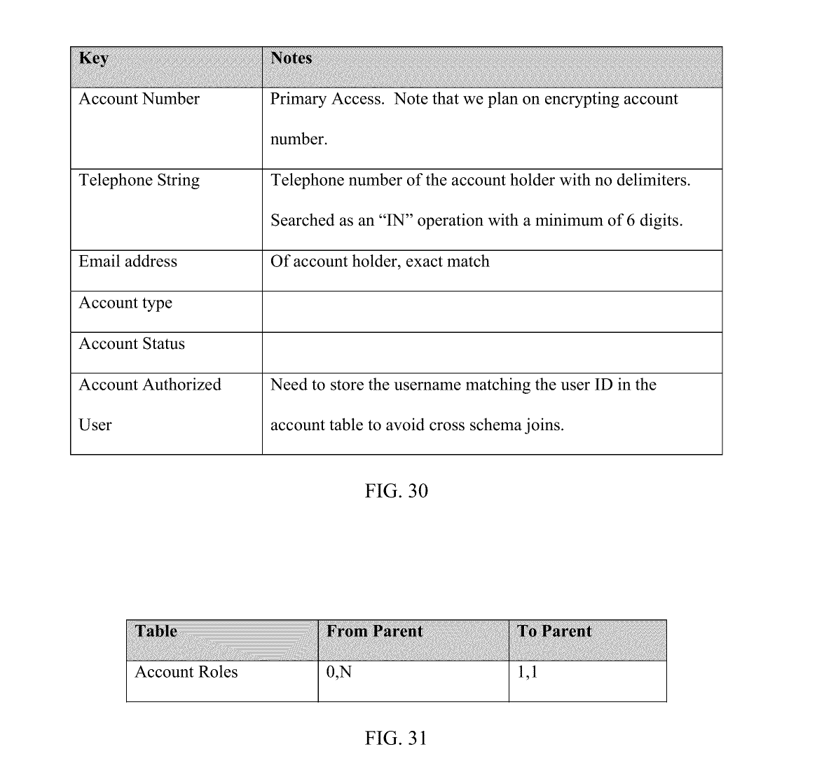

FIG. 30 show search keys that may be used to access a credit account according to an exemplary embodiment of the present invention. All key values may be “anded” in the search.

Accesses

The accesses table may be a log of account accesses and transactions that change the account in any way. For example, a change to a credit limit, an adjustment, a payment applies, or the addition of an authorized user. It may not include sales transactions.

Authorized Users

The authorized users table links a profile of a given type to a credit account as an authorized user. The account holder may be an authorized user. Authorized users may include internal agents (employees of the airline), consumers, agency agents, and corporate administrators. The authorized user may be passed in every transaction, and is assumed to be logged into TDP.

Child Tables

FIG. 31 shows a child table that may be associated with an Authorized User according to an exemplary embodiment of the present invention.

Notes

The notes table may store general notes for a credit account. Notes may contain the user who created the note and the date and time.

Transaction Summary

The transaction summary table may be a counter summary table of transactions on an account that keeps a balance of all charges and credits to the account. In an exemplary embodiment, the transaction summary table is not part of the object model, but is used to quickly return the account balance and the remaining credit balances when credit limits are employed.

The transactions summary table may only ever have one row in it, and may be separated from the credit account table to avoid locking problems. The transactions summary table may be locked and updated for every transaction inserted into the transaction table. The commitment boundary may be shared by both tables to ensure integrity of the numbers.

The transactions summary table may be capable of being “re-rolled” by a java process or stored procedure that process all transactions and updates the totals periodically.

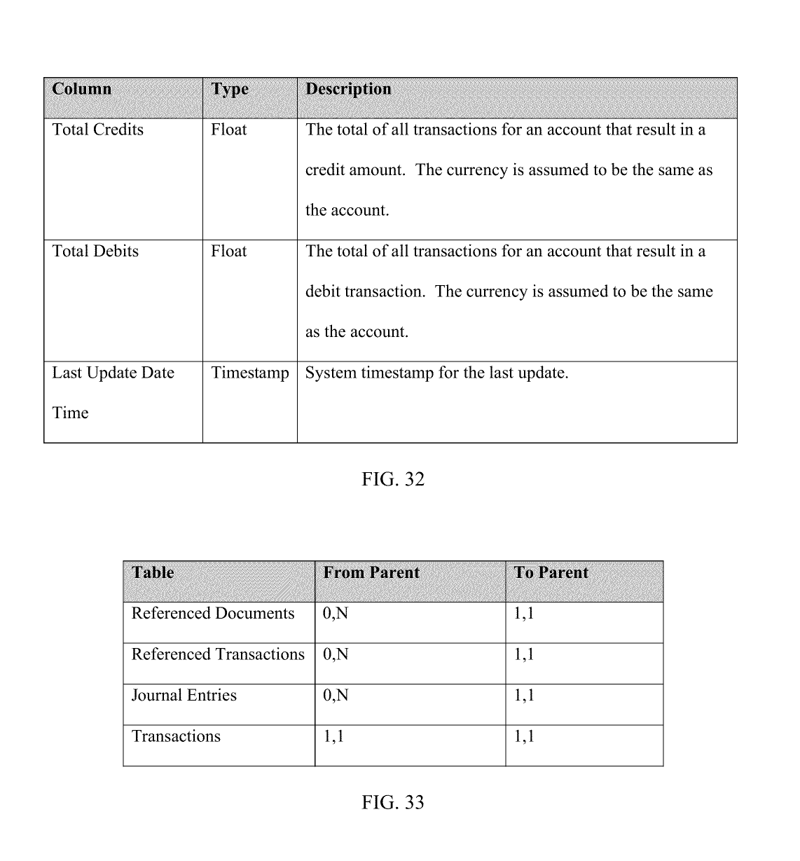

FIG. 32 provides a table of definitions according to an exemplary embodiment of the present invention.

Transactions

The transactions table may provide a journal of all transactions made for a credit account. Every sale authorization, sale capture, adjustment, payment, etc. may be recorded in the transaction table. The transactions table may be sizeable (greater than 1 million records).

A transaction may be inserted into the table for each transaction made. In some cases, the transaction will be updated. For example, in the case of an authorized sale, an update is made when the sale is captured.

Authorization, Decline, and Capture

The credit bank may support a cycle of authorization and capture of sales and sale credits. If the client request is to authorize a sale and the transaction amount is within the limits of the account, the transaction may be inserted into the transaction table with a system unique authorization code, authorization date/time, and an authorization expiration date/time. The expiration date/time duration may be set by system value.

The authorization code and date/time may be returned to the client. The client can call back to capture or void the transaction with the account code, authorization date, and authorization code. The transaction may be selected by authorization code, and date, and the capture information may be updated given that the transaction is verified within the limits of the account. A system unique capture code may be returned, and the posted date and time information may be updated.

If the client requests to void the transaction, the void date/time may be set as the disposition of the transaction. In an exemplary embodiment, voided transactions are never counted in system limits.

In an embodiment, the system comprises a computer program module and/or portions of computer code configured to record declined transactions. A declined transaction occurs when there is not enough of a credit balance on an account to authorize the sale, or if the account is suspended. The transaction disposition may be set to void. In an exemplary embodiment, voided transactions are never counted in system limits.

Authorization and capture codes may be system unique within a (system) day. The date portion of the authorization date/time may be returned in a request to capture or void an authorization.

Currency

All transactions may be recorded in the currency of the account. This is because the balances may need to be consistent, and the agreed currency for the account may be a business agreement with the airline's customer.

If the credit transaction was generated by a document redemption, refund, etc. that was in a different currency than the account currency, this may be the other currency amount, code and exchange rate.

Child Tables

FIG. 33 show the child tables associated with the transaction table according to an exemplary embodiment of the present invention.

The referenced transactions table may have a recursive relationship in that the table may contain a reference to a different transaction than it is owned by.

Alternate Indexes

Indexes may be added for the transactions supported as needed or for tuning purposes as the need arises.

Referenced Documents

The referenced documents table may store documents referenced by a credit transaction. For example, if a document was redeemed into, or purchased from the credit account, this is a reference to the document. An example of a redeemed document is a refunded or residual value exchanged air ticket, a gift certificate redeemed, etc. An example of a purchased document is an air ticket paid with a credit account.

Referenced Transactions

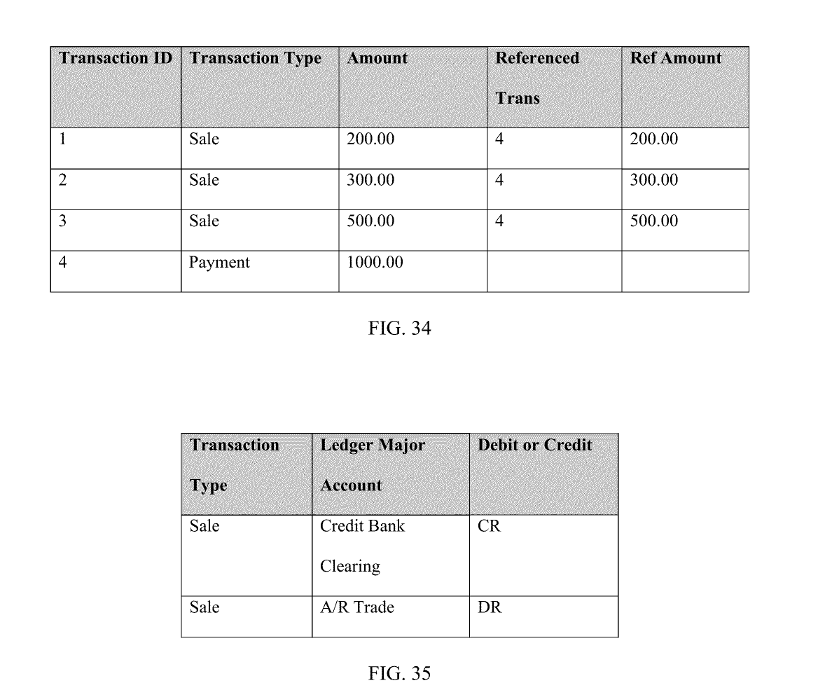

The referenced transactions table may record cross references to transactions that reference one another. Referenced transactions may link a transaction to other transactions. For example, when applying payments to an invoice, the total payment transaction is posted in detail to each charge transaction being paid. FIG. 34 shows a referenced transactions table according to an exemplary embodiment of the present invention.

Referenced transactions may not affect the balance of the account, and they may only serve to provide functionality such as account ageing.

Journal Entries

A journal may document a transaction for import into a financial system. The journal table may be used to create a balanced journal to financial accounts that act as a sub-ledger to a financial account. The journals may be created when each transaction that has an effect on the ledger is posted. There may be at least two journals for each transaction as there is always a balanced posting.

Journals may be transmitted to the airline's financial system on a periodic basis. When they are successfully transmitted they may be marked with a posted date time. Once posted, they may never again be included in a journal export.

The journals can be “rolled” off the system on a rolling yearly basis.

Transaction Type

The transaction type table may be a master table that defines credit bank transaction types. The system may be delivered with the transaction types in place. These transaction types may match the transactions that credit bank supports, for example, Sale, Payment, etc.

The transaction type table may include rules that dictate what major ledger accounts journals are produced for and whether to debit or credit the account. FIG. 35 shows a transaction type table according to an exemplary embodiment of the present invention.

The transaction type can also dictate things like the number of days a credit transaction is valid for.

Child Tables

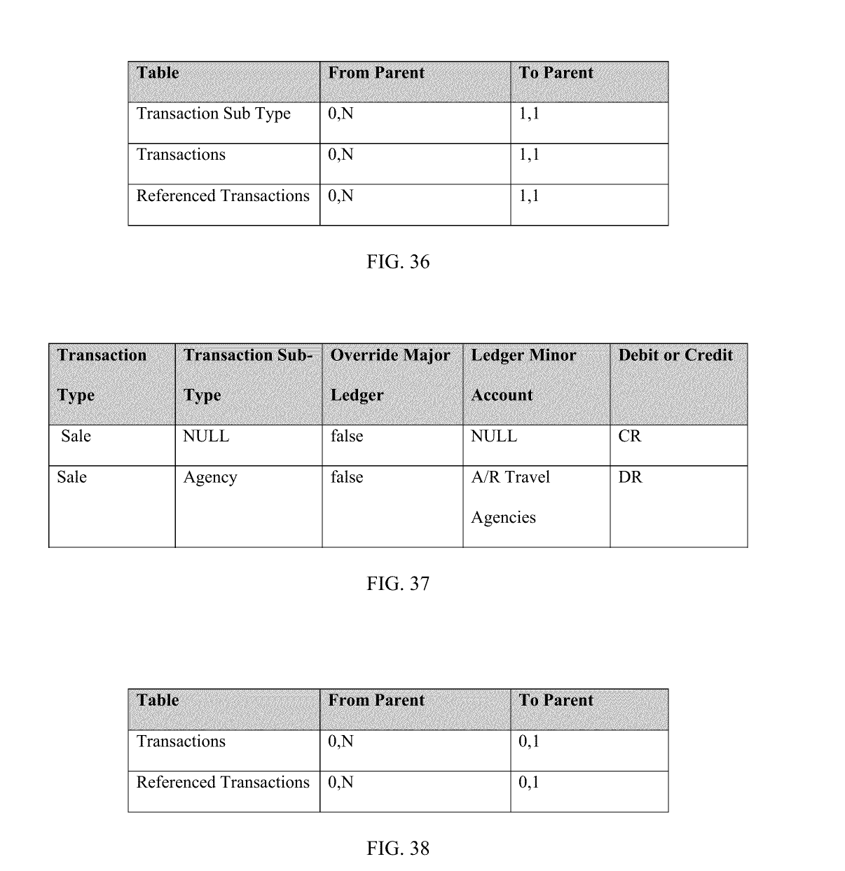

FIG. 36 shows the child tables associated with a transaction type table according to an exemplary embodiment of the present invention.

Transaction Sub-Type

The transaction sub-type table may be a master table that defines credit bank transaction sub-types. The sub-types may be user-definable and can be maintained by the airline's system administrator. The transaction sub-type may be a child of transaction type.

The transaction sub-type table may include what minor ledger accounts journals are produced for, whether to override the transaction type ledger account number or combine the ledger account numbers and whether to debit or credit the account. FIG. 37 shows a transaction sub-type table according to an exemplary embodiment of the present invention.

Given a business rule that states (IF Credit Account Type=Agency THEN True) the example shown in FIG. 37 may produce a balanced journal like:

CR Credit Bank Clearing 100.00

DR A/R Trade, Travel Agencies 100.00

Child Tables

FIG. 38 show the child tables associated with a transaction sub-type table according to an exemplary embodiment of the present invention.

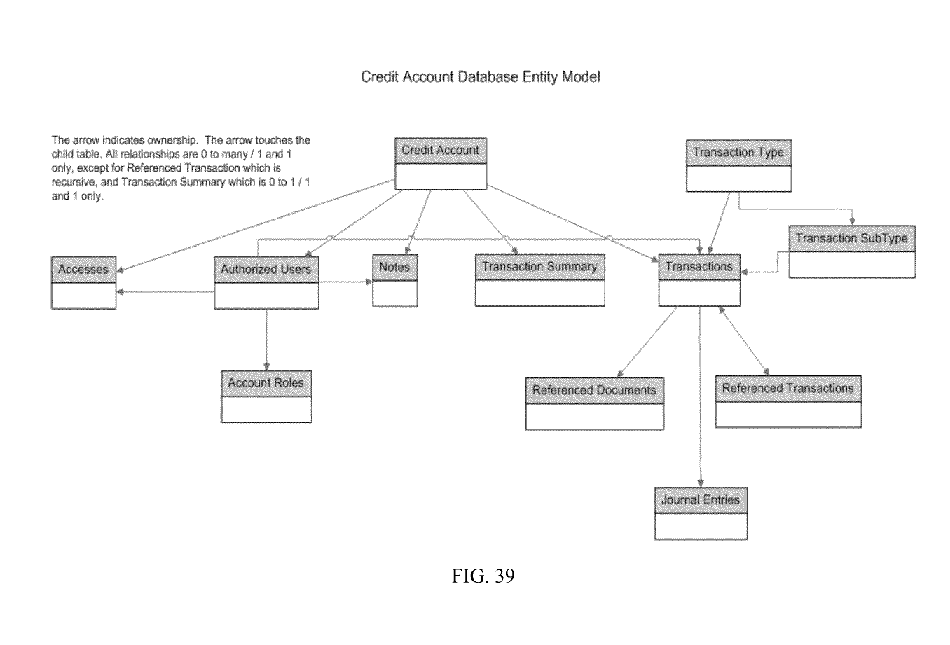

FIG. 39 is a diagram showing a credit account database entity model according to an exemplary embodiment of the present invention.

In an exemplary embodiment, the system 1 may include the feature of eCertificates (for example, TDP eCertificates) that provide an airline the ability to sell and accept electronic gift certificates on their website or other direct channels. The feature may include an online purchase flow that allows the customer to design a personalized gift certificate for any amount within the limits set by the airline. The system 1 may comprise a computer program product and/or portions of computer code running on one or more processors either locally or directed through the internet, such computer program product and/or computer code configured to enable, facilitate, and/or otherwise provide the input and/or output of data by, e.g., a user to buy, sell, design, or otherwise utilize an electronic gift certificate.

In an embodiment, the system 1 including a gift certificate feature comprises a computer program module and/or portions of computer code which enables, facilitates, or otherwise provides for the personalized gift certificate to be securely emailed to the recipient who, on receipt, is directed back to the airline's website to activate the gift certificate and set a security PIN. In an embodiment, the system 1 including a gift certificate feature comprises a computer program module and/or portions of computer code which enables, facilitates, or otherwise provides for the gift certificate to be used, one activated, as a form of payment for direct channel purchases subject to the terms of use set by the airline.

In an embodiment, the system 1 including a gift certificate feature comprises a computer program module and/or portions of computer code which enables, facilitates, or otherwise provides for the gift certificate to be used in conjunction with any other form of payment to pay for items in the shopping cart subject to validation rules set by the airline. For example, the airline may require that gift certificates are only used for flight itineraries operated solely by the airline.

The airline may be able to flexibly set terms and conditions for use including:

Minimum and Maximum Values and Currency

Currency Increments (multiples of $5.00, etc.) or Any Amount

Maximum Number of Certificates in One Purchase

Valid Form of Payment Combinations

Valid Credit Card Countries for Purchase

Refund and Transfer

Number of Days/Hours to Activate

Number of Days Until Expiration

Require Login to Purchase or Not

Require Login to Use or Not

Valid Item Types for Purchase

Air Itinerary Validation for Purchase

In an embodiment, the system 1 including a gift certificate feature comprises a computer program module and/or portions of computer code which may include consumer facing user interfaces to allow the recipient of a gift certificate to inquire on the balances and sales transactions made against the gift certificates he holds.

In an embodiment, the system 1 including a gift certificate feature comprises a computer program module and/or portions of computer code which include certificate management screens which act as an interface for, e.g., the airline administrator to inquire on certificate balances and transactions. The computer program module and/or computer code encoding the interface comprising these screens may also provide the ability to:

Void, Refund, or Cancel a Certificate

Reset the PIN of a Certificate

Transfer a Certificate

Expire or Extend the Expiry of a Certificate

Adjust a Certificate Balance

Correct the Email Address of the Recipient of a Certificate

In an embodiment, the system 1 including a gift certificate feature comprises a computer program module and/or portions of computer code which enable, facilitate or otherwise provide a web-service based authorization and capture process that validates the balance of certificates to be used in a sale, and tracks certificate use, exchange, and refund. The gift certificate authorization and capture services may be used in the existing TDP Consumer flows for accepting gift certificates by “plugging” the services in TDP Payment Gateway Adaptors. An additional inquiry web service may be provided to allow the client computer program product to check the existing balance of one or more certificates.

In an embodiment, the system 1 including a gift certificate feature comprises a computer program module and/or portions of computer code which enable, facilitate or otherwise provide a daily process to produce transaction reports that detail the purchase of new gift certificates and use, refund, expiry, and adjustment of existing gift certificates. These reports may be used to reconcile with sales and treasury reports from non-TDP sources.

In an embodiment, the daily, e.g. nightly, process may include the sending of reminder emails to recipients and purchasers where certificates have been issued and not activated for some number of days after the planned delivery date. The process may also email the purchaser where en email attempt to the recipient has failed. This is to ensure that the purchaser has not mistakenly entered an invalid email address.

Purchase a Gift Certificate

In an embodiment, the system 1 including a gift certificate feature comprises a computer program module and/or portions of computer code which enable, facilitate or otherwise provide a consumer facing gift certificate purchase flow. The flow may include an interface comprising three pages, including, for example, Personalize, Purchase, and Confirmation pages. In an embodiment, the flow may also include a Terms and Conditions page.

Personalize

In an embodiment, the system 1 including a gift certificate feature comprises a computer program module and/or portions of computer code which direct the purchaser of a gift certificate to the following page that allows him to personalize the certificate and set its value.

Content

In an embodiment, the system 1 including a gift certificate feature comprises a computer program module and/or portions of computer code which enable, facilitate or otherwise provide a Personalize page that contain a block of content that describes the gift certificate personalization and purchase process to the purchaser along with high level terms and conditions and other information about the gift certificate program.

Terms and Conditions

In an embodiment, the system 1 including a gift certificate feature comprises a computer program module and/or portions of computer code which enable, facilitate or otherwise provide a Terms and Conditions page that displays the written terms and conditions for purchase and use of gift certificates. In an embodiment, the terms and conditions may be stored with the gift certificate product configuration within TDP. In an embodiment, when a gift certificate is sold, the terms and conditions may be copied to the TDP reservation.

Certificate Templates

In an embodiment, the system 1 including a gift certificate feature may comprise a computer program module and/or portions of computer code which provide a number of different styles of templates for the certificates in a Certificate Templates feature that can be applied to the email gift certificate. In an embodiment, the purchaser can select from the available templates by selecting a style from the slider of thumbnails below the gift certificate image. As the purchaser selects a style, it may be applied to the gift certificate image.

Certificate Amount

In an embodiment, the system 1 including a gift certificate feature may comprise a computer program module and/or portions of computer code which enables, facilitates, or otherwise provides for the purchaser to enter or select the amount of the gift certificate. When the amount is entered, or selected, the amount shows up in the gift certificate image. The airline can specify in the configuration of the gift certificate product setup, the minimum, maximum, and optionally, increments in value of the certificate. If the certificate product is configured to be bought in increments, they may be shown as a dropdown instead of an entry field.

Recipient's Name

In an embodiment, the system 1 including a gift certificate feature may comprise a computer program module and/or portions of computer code which enables, facilitates, or otherwise provides for the purchaser to enter the name of the recipient, and the name may be shown on the face of the gift certificate image.

Sender's Name

In an embodiment, the system 1 including a gift certificate feature may comprise a computer program module and/or portions of computer code which enables, facilitates, or otherwise provides for the purchaser to enter the sender's name, and the name may show on the face of the gift certificate image.

Personal Message

In an embodiment, the system 1 including a gift certificate feature may comprise a computer program module and/or portions of computer code which enables, facilitates, or otherwise provides for the purchaser to enter a personal message to appear on the face of the gift certificate.

Recipient's Email Address

In an embodiment, the system 1 including a gift certificate feature may comprise a computer program module and/or portions of computer code which enables, facilitates, or otherwise provides for the purchaser to enter and confirm the recipient's email address. This may be very important as it may be the only required identification of the recipient and may later be used to track a certificate to the recipient's account when she identifies herself in the activation flow.

Activation Challenge

In an embodiment, the system 1 including a gift certificate feature may comprise a computer program module and/or portions of computer code which enables, facilitates, or otherwise provides for the gift certificate product to be configured to require that the purchaser indicate a snippet of information that the recipient will know. This snippet of information may be required in the activation process to activate the certificate to provide an additional measure of security. The types of challenger information may be the recipient's postal code, the numbers in the recipient's address, or the last 4 digits of the recipient's phone number.

Deliver On

In an embodiment, the system 1 including a gift certificate feature may comprise a computer program module and/or portions of computer code which enables, facilitates, or otherwise provides for the gift certificate product to be configured with a mandatory waiting period before a certificate can be activated. This is to allow time for the funds used to purchase the gift certificate to be collected or to be sure the credit card transaction has passed fraud check.

In addition to the mandatory waiting period, the gift certificate product can be configured to allow a scheduled notification to the recipient. This supports holding off on delivery until a person's birthday, for example. If the certificate product is configured for scheduled delivery, the calendar selection for the delivery date may start on the day after the mandatory waiting period configured.

Email Terms and Conditions

In an embodiment, the system 1 including a gift certificate feature may comprise a computer program module and/or portions of computer code which enables, facilitates, or otherwise provides for the gift certificate product to be configured to require that the purchaser accept terms and conditions that they have entered a valid email address. If an invalid email address is entered, the recipient may fail to receive the gift certificate.

Add Another

In an embodiment, the system 1 including a gift certificate feature may comprise a computer program module and/or portions of computer code which enables, facilitates, or otherwise provides for the purchaser to click an Add Another button to add another gift certificate to the shopping cart. The gift certificate product can be configured with a maximum number of certificates that can be purchased in one session. The airline may consider this maximum when determining the maximum value to allow for each certificate.

Check Out

In an embodiment, the system 1 including a gift certificate feature may comprise a computer program module and/or portions of computer code which enables, facilitates, or otherwise provides for the purchaser to click Check Out and be directed to the Payment Page when he has personalized all the gift certificates he wants to buy in a session.

Payment

In an embodiment, the system 1 including a gift certificate feature may comprise a computer program module and/or portions of computer code which enables, facilitates, or otherwise provides for the Purchaser to enter payment information and finish the sale.

Shopping Cart Recap

In an embodiment, the system 1 including a gift certificate feature may comprise a computer program module and/or portions of computer code which enables, facilitates, or otherwise provides for a Shopping Cart Recap page following the paradigm of the TDP Consumer UI. This recap may appear at the top or sides of the page and/or contain a breakdown of all certificates to be issued and their amounts. It may also show any fees assessed by the airline for issuing the certificates. The fees can be configured in the gift certificate product setup.

Credit Card Information

In an embodiment, the system 1 including a gift certificate feature may comprise a computer program module and/or portions of computer code which only allows for credit card forms of payment to be entered by, e.g., a user and/or used for gift certificate purchase for the first delivery of gift certificates. The purchaser may enter standard credit card information on this section.

The purchaser may enter and confirm his email address and phone number so that an email receipt can be sent and there a phone contact if there are any exceptions to the certificate processing.

Terms and Conditions

In an embodiment, the system 1 including a gift certificate feature may comprise a computer program module and/or portions of computer code which prompts the purchaser to accept the terms and conditions for the gift certificate product. The user may click the terms and conditions link to display the terms and conditions. When the user clicks the Continue button, the page may invoke the service side of the purchase flow.

Service Flow

In an embodiment, the system 1 including a gift certificate feature comprises a computer program module and/or portions of computer code which enable, facilitate or otherwise provide a Payment page that invokes two existing TDP business services, Reservation Add and Reservation Purchase. In an embodiment, these two services and a new Reservation Document Adaptor Service may manage the purchase and issue of the gift certificate(s).

Reservation Add

In an embodiment, the interface to the Reservation Add Service may be modified to accept priced certificate options as a new priced option type. The TDP Reservation object may be modified to add an Itinerary Segment structure to accommodate eCertificates.

In an embodiment, the Payment page may call Reservation Add to add all gift certificates in the shopping cart to a new TDP Reservation. Any fees charged for the issuance of eCertificates may be added to the reservation as Fee components.

Reservation Purchase

In an embodiment, the system 1 including a gift certificate feature may comprise a computer program module and/or portions of computer code calls for a Reservation Purchase page after successful response from Reservation Add. The purchaser's card and address information may be passed and may include the customer information in the reservation.

The Reservation Purchase may construct the Reservation Invoice as normal adding all certificate and fee components to the invoice. One payment schedule may be processed for all certificates and fees.

The Reservation Purchase service may resolve a payment authorization adaptor.

Customers who do not currently have a stand-alone payment service gateway, may need to select a payment gateway provider and the system may need to implement a payment adaptor for the payment processor if a product version does not exist.

When payment authorization is successful, the Reservation Purchase may call Reservation Document. The eCertificate project may provide a new Reservation Document Adaptor service that will:

Create the Certificate(s)—A record is written to the Certificate tables including all the information about the certificate's purchaser, recipient, value, fee charged, etc. (See Certificate Model). The gift certificate may be set to an “Issued” state, but is not yet active and cannot be used.

Create and Send the Purchaser's Confirmation—A confirmation email containing a list of all certificates issued and fees charges is sent to the purchaser's email address.

Schedule Delivery of the Gift Certificate—Based on the activation delay time configured in the gift certificate product and any future scheduling set by the purchaser, a delivery date is set and updated into the certificate.

Update the TDP Reservation—The TDP Reservation components for the certificates and fees are marked booked, and the document numbers and payment information is recorded in the document and provider payment elements of the reservation component(s). The Reservation document service may create daily sales journals to record the sale of the gift certificates as well as any fees collected. These journals may be extracted for delivery to the airline's financial system. Control returns to the user interface and the purchaser may be shown a confirmation page recapping the transaction.

Confirmation Page

In an embodiment, the system 1 including a gift certificate feature may comprise a computer program module and/or portions of computer code which shows a confirmation page that recaps all certificates purchased, the recipients, and amounts as well as payment and purchaser information and terms and conditions of the gift certificate sale. Only the last 4 digits of the newly issued certificates may be shown.

Confirmation Email

In an embodiment, the system 1 including a gift certificate feature may comprise a computer program module and/or portions of computer code which enable, facilitate, or otherwise provide for a confirmation email to be sent to the purchaser that recaps all certificates purchased, the recipients, and amounts as well as payment and purchaser information and terms and conditions of the gift certificate sale. Only the last 4 digits of the newly issued certificates may be shown

Gift Certification Activation

In an embodiment, the system 1 including a gift certificate feature may comprise a computer program module and/or portions of computer code which “issues” a gift certificate when it is purchased, and assigns a gift certificate number, but the certificate may not be “active” and may not be capable of use. In an exemplary embodiment, to activate the certificate the recipient must come back to the airline's website to select a PIN number and activate the certificate.

Notification Email

On the specified delivery date for the certificate, the eCertificate system comprises a computer program module and/or portions of computer code which enable, facilitate or otherwise provide for an email to be sent to the recipient. The email may contain the gift certificate image as it was designed by the purchaser including the personalized message and style. Instead of the gift certificate number at the bottom of the gift certificate image there may be a link with instructions to the recipient that they should click the link to be directed back to the airline's website to activate the certificate for use.

Set PIN and Activate Gift Certificate without a User Profile

In an embodiment, the system 1 including a gift certificate feature may comprise a computer program module and/or portions of computer code which direct the customer back to the Airline's website to set a PIN and activate the certificate for use.

In an embodiment, the certificate may be shown pending activation.

PIN Number

In an embodiment, the system 1 including a gift certificate feature comprises a computer program module and/or portions of computer code which enable, facilitate or otherwise provide for a recipient to enter a PIN number and confirm the number by re-entering it. The PIN number may be required to use, manage, and inquire against the certificate. In an exemplary embodiment, the PIN number is never transmitted by email. It may be stored as encrypted data in the certificate database.

Challenge Snippet

In an embodiment, the system 1 including a gift certificate feature comprises a computer program module and/or portions of computer code which enable, facilitate or otherwise provide for a recipient to enter information in a challenge field if the purchaser was required to enter a bit of information to challenge the activation of the certificate. In an embodiment, a hyperlink next to the field may explain the challenge field when clicked.

Recipient Contact Information

In an embodiment, the system 1 including a gift certificate feature comprises a computer program module and/or portions of computer code which enable, facilitate or otherwise provide for a recipient to be prompted to enter her name and contact information. This information may be used in case the airline needs to contact the recipient, or so that the recipient can identify in a phone contact with the airline. The contact information may also serve as the default customer name and address information in the payment flow on the consumer UI.

Terms and Conditions

In an embodiment, the system 1 including a gift certificate feature comprises a computer program module and/or portions of computer code which enable, facilitate or otherwise provide for a recipient to accept the terms and conditions of use. The terms and conditions may have been set up in the gift certificate product configuration.

Activate the Certificate

In an embodiment, the system 1 including a gift certificate feature comprises a computer program module and/or portions of computer code which enable, facilitate or otherwise provide for, or communicate with, an eCertificate web-service to be called to activate the gift certificate that was created in the purchase flow. In an embodiment, the recipient's contact information may be updated and the PIN stored. The status of the certificate may be set to active, pending the airline's required waiting period.

Activation Email Without User Profile

In an embodiment, the system 1 including a gift certificate feature comprises a computer program module and/or portions of computer code which enable, facilitate or otherwise provide for an activation email to be sent to the recipient. This email may contain the gift certificate with the certificate number exposed. The recipient may print and save the certificate from her email account.

Set PIN and Activate Gift Certificate with a User Profile

If the airline's gift certificate program requires that the recipient have a user profile and login on the airlines website to activate and use the gift certificate the activation flow may be slightly different.

The recipient may have an existing profile and login on the airline's website, or can quickly create one from the PIN activation screen. The recipient may also access the normal website signup and create profile and username.

Quick Add a Profile

In an embodiment, the system 1 including a gift certificate feature comprises a computer program module and/or portions of computer code which enable, facilitate or otherwise provide for a recipient to click a check box to activate a quick profile information panel. The recipient may enter a username, password and password confirmation. She then may enter her contact information including an alternate email address. The email address used in the certificate transaction may default to the email address of the profile.

Terms and Conditions

In an embodiment, the system 1 including a gift certificate feature comprises a computer program module and/or portions of computer code which enable, facilitate or otherwise provide for a recipient to accept both terms and conditions of the website and the certificate program.

Activate the Certificate and Create Profile

In an embodiment, the system 1 including a gift certificate feature comprises a computer program module and/or portions of computer code which enable, facilitate or otherwise provide for the PIN and contact information to be saved in the certificate record in the eCertificate database when a recipient clicks the Activate link. Additionally, the TDP Profile Create may be called to create a profile and user. In an exemplary embodiment, the profile is not linked to the certificate in this step.

In an embodiment, the system 1 including a gift certificate feature comprises a computer program module and/or portions of computer code which enable, facilitate or otherwise provide for an email to be sent to the recipient at the address set up at purchase time. The email may contain an image of the certificate, but in place of the certificate number there is a link that brings the recipient back to the airline's website to sign in, activate, and link the certificate to her profile.

Activation Email with User Profile

In an embodiment, the system 1 including a gift certificate feature comprises a computer program module and/or portions of computer code which enable, facilitate or otherwise provide for an Activation Email With User Profile landing page on which the recipient may log in with a valid username and password. When she logs in successfully, she may be prompted to link the certificate to her profile. To do so, she may enter the PIN she created and any challenge snippet required. The PIN may be verified against the certificate embedded in the email link and the certificate may be activated and linked to the profile.

In an embodiment, the system 1 including a gift certificate feature comprises a computer program module and/or portions of computer code which enable, facilitate or otherwise provide for the certificate record tp be linked to the user profile of the recipient upon successful activation. The MyeCertificates section of the screen may be populated with the newly added certificate information. In an embodiment, the system 1 including a gift certificate feature comprises a computer program module and/or portions of computer code which enable, facilitate or otherwise provide for the certificate to be used upon this successful activation. The added benefit of linking to a profile is that the recipient will see the certificates available and valid for use on the payment page of the Consumer UI when she is logged in.

While particular embodiments of the invention have been illustrated and described, it would be obvious to those skilled in the art that various other changes and modifications may be made without departing from the spirit and scope of the invention. It is therefore intended to cover in the present disclosure all such changes and modifications that are within the scope of this invention.

What is claimed is:

1. A method comprising:
providing, by one or more computers, a credit bank database comprising data associated with credit accounts assigned to one or more respective customers by one or more respective travel product providers, the credit accounts associated with credit in a first currency and issued by a variety of different types of credit issuers;
receiving, by the one or more computers, a request from at least one of one or more user computer systems to purchase a travel product from at least one of the one or more travel product providers using a respective credit account of at least one of the one or more customers;
determining, by the one or more computers, whether to accept or deny the request based on one or more conditions;
upon the condition that the request is accepted, facilitating, by the one or more computers, purchase of the travel product using the at least a portion of available credit held within the respective credit account of the at least one of the one or more customers, the step of facilitating comprising converting the at least a portion of available credit to a second currency associated with the request;
upon the condition that the request is denied, refusing, by the one or more computers, purchase of the travel product using the respective credit account of the at least one of the one or more customers; and
communicating, by the one or more computers, the acceptance or denial to the one or more user computer systems.

2. The method of claim 1, wherein the variety of different types of credit issuers comprise credit issuer types selected from the group consisting of: travel banks, corporate servers, travel agency servers, electronic profile systems and loyalty award databases.

3. The method of claim 1, wherein the step of determining whether to accept or decline the request comprises:
determining, by the one or more computers, whether to authorize the purchase; and
determining, by the one or more computers, whether to capture the purchase.

4. The method of claim 3, wherein the step of determining whether to authorize the purchase is based on whether a first set of conditions is met, the first set of conditions comprising one or more of the following:
a credit account number of the respective credit account is valid;
the respective credit account is not suspended;
the respective credit account is not closed;
the at least one of the one or more user computer systems is associated with an authorized user of the respective credit account;
a PIN matches that of an authorized user of the respective credit account;
an amount authorized for the purchase is a positive amount;
an available balance in the respective credit account is greater than or equal to an amount of the purchase;
an available daily balance in the respective credit account is greater than or equal to the purchase amount; and
the respective credit account is indicated as being available for the purchase.

5. The method of claim 3, wherein the step of determining whether to capture the purchase is based on whether a second set of conditions is met, the second set of conditions comprising one or more of the following:
a credit account number of the respective credit account is valid;
the respective credit account is not suspended;
the respective credit account is not closed;
the at least one of the one or more user computer systems is associated with an authorized user of the respective credit account;
a PIN matches that of an authorized user of the respective credit account;
an amount authorized for the purchase is a positive amount;
an available balance in the respective credit account is greater than or equal to an amount of the purchase;
an available daily balance in the respective credit account is greater than or equal to the purchase amount;
the respective credit account is indicated as being available for the purchase;
an expiration date of an authorization is not exceeded.

6. The method of claim 1, further comprising the steps of:
tracking, using the one or more computer systems, expiration of the credit in the one or more credit accounts; and
updating, using the one or more computer systems, the one or more credit account based on the tracked expiration.

7. The method of claim 1, further comprising the step of generating, by the one or more computers, one or more general ledger journals based on the requested purchase.

8. The method of claim 7, further comprising the step of sending, by the one or more computers, the one or more general ledger journals to the travel product provider computer system.

9. The method of claim 1, wherein the credit comprises types of credit selected from the group consisting of: loyalty accrual/redemption, tickets purchases, flight changes/cancellations, service exception compensation, gift card purchase/redemption, promotional offers and ancillary purchases.

10. A system comprising:
one or more data processing apparatus; and
a non-transitory computer-readable medium coupled to the one or more data processing apparatus having instructions stored thereon which, when executed by the one or more data processing apparatus, cause the one or more data processing apparatus to perform a method comprising:
providing, by one or more computers, a credit bank database comprising data associated with credit accounts assigned to one or more respective customers by one or more respective travel product providers, the credit accounts associated with credit in a first currency and issued by a variety of different types of credit issuers;
receiving, by the one or more computers, a request from at least one of one or more user computer systems to purchase a travel product from at least one of the one or more travel product providers using a respective credit account of at least one of the one or more customers;
determining, by the one or more computers, whether to accept or deny the request based on one or more conditions;
upon the condition that the request is accepted, facilitating, by the one or more computers, purchase of the travel product using the at least a portion of available credit held within the respective credit account of the at least one of the one or more customers, the step of facilitating comprising converting the at least a portion of available credit to a second currency associated with the request;
upon the condition that the request is denied, refusing, by the one or more computers, purchase of the travel product using the respective credit account of the at least one of the one or more customers; and
communicating, by the one or more computers, the acceptance or denial to the one or more user computer systems.

11. The system of claim 9, wherein the variety of different types of credit issuers comprise credit issuer types selected from the group consisting of: travel banks, corporate servers, travel agency servers, electronic profile systems and loyalty award databases.

12. The system of claim 9, wherein the step of determining whether to accept or decline the request comprises:
determining, by the one or more computers, whether to authorize the purchase; and
determining, by the one or more computers, whether to capture the purchase.

13. The system of claim 12, wherein the step of determining whether to authorize the purchase is based on whether a first set of conditions is met, the first set of conditions comprising one or more of the following:
a credit account number of the respective credit account is valid;
the respective credit account is not suspended;
the respective credit account is not closed;
the at least one of the one or more user computer systems is associated with an authorized user of the respective credit account;
a PIN matches that of an authorized user of the respective credit account;
an amount authorized for the purchase is a positive amount;
an available balance in the respective credit account is greater than or equal to an amount of the purchase;
an available daily balance in the respective credit account is greater than or equal to the purchase amount; and
the respective credit account is indicated as being available for the purchase.

14. The system of claim 12, wherein the step of determining whether to capture the purchase is based on whether a second set of conditions is met, the second set of conditions comprising one or more of the following:
a credit account number of the respective credit account is valid;
the respective credit account is not suspended;
the respective credit account is not closed;
the at least one of the one or more user computer systems is associated with an authorized user of the respective credit account;
a PIN matches that of an authorized user of the respective credit account;
an amount authorized for the purchase is a positive amount;
an available balance in the respective credit account is greater than or equal to an amount of the purchase;
an available daily balance in the respective credit account is greater than or equal to the purchase amount;
the respective credit account is indicated as being available for the purchase;
an expiration date of an authorization is not exceeded.

15. The system of claim 9, further comprising the steps of:
tracking, using the one or more computer systems, expiration of the credit in the one or more credit accounts; and
updating, using the one or more computer systems, the one or more credit account based on the tracked expiration.

16. The system of claim 9, further comprising the step of generating, by the one or more computers, one or more general ledger journals based on the requested purchase.

17. The system of claim 16, further comprising the step of sending, by the one or more computers, the one or more general ledger journals to the travel product provider computer system.

18. The system of claim 9, wherein the credit comprises types of credit selected from the group consisting of one or more of the following credit types: loyalty accrual/redemption, tickets purchases, flight changes/cancellations, service exception compensation, gift card purchase/redemption, promotional offers and ancillary purchases.
